(19) United States
(12) Patent Application Publication
(10) Pub. No.: US 2024/0112395 A1
(43) Pub. Date: Apr. 4, 2024

(54) IMAGE PROCESSING DEVICE, IMAGE PROCESSING METHOD, AND PROGRAM

(71) Applicant: FUJIFILM Corporation, Tokyo (JP)

(72) Inventor: Yuka OYAMA, Tokyo (JP)

(73) Assignee: FUJIFILM Corporation, Tokyo (JP)

(21) Appl. No.: 18/472,270

(22) Filed: Sep. 22, 2023

(30) Foreign Application Priority Data
Sep. 30, 2022 (JP) 2022-159105

(51) Int. Cl. G06T 15/20; G06F 3/14

(52) U.S. Cl. CPC G06T 15/20; G06F 3/14

(57) ABSTRACT

An image processing device includes a processor, in which the processor is configured to receive a setting of a cut section with respect to an organ shown by a three-dimensional image, and output, as a first display image that is generated by rendering based on the three-dimensional image and shows the organ, a side viewpoint image having a side viewpoint at which the set cut section is viewed from a direction intersecting a normal line of the cut section, set as a viewpoint of the rendering.

### CROSS-REFERENCE TO RELATED APPLICATIONS

This application claims priority from Japanese Patent Application No. 2022-159105, filed Sep. 30, 2022, the entire disclosure of which is incorporated herein by reference.

### BACKGROUND OF THE INVENTION

### 1. Field of the Invention

A technique of the present disclosure relates to an image processing device, an image processing method, and a program.

### 2. Description of the Related Art

JP2021-166706A describes an image-guided surgery system. In JP2021-166706A, a virtual camera may be positioned with respect to a 3D model of an anatomy of a patient to provide a virtual camera view of a surrounding anatomy and a tracked surgical instrument deployed to the anatomy. Visual context provided by the virtual camera may be limited in a case where the surgical instrument is being used in a very narrow anatomical passageway or cavity, or the like. To provide more disposition flexibility, an image-guided surgery (IGS) system that provides a virtual camera receives an input for defining variable visual characteristics of different segments or regions of the 3D model, which may include hiding a specific segment or making the specific segment semi-transparent. With such a system, the view of the 3D model provided by the virtual camera view can be corrected to remove or deemphasize less relevant segments, to display or emphasize more relevant segments (for example, a critical anatomy of the patient), or both.

### SUMMARY OF THE INVENTION

An embodiment according to the technique of the present disclosure provides an image processing device, an image processing method, and a program that enable confirmation of a side viewpoint image of a cut section with a simple operation.

A first aspect according to the technique of the present disclosure is an image processing device comprising a processor, in which the processor is configured to receive a setting of a cut section with respect to an organ shown by a three-dimensional image, and output, as a first display image that is generated by rendering based on the three-dimensional image and shows the organ, a side viewpoint image having a side viewpoint at which the set cut section is viewed from a direction intersecting a normal line of the cut section, set as a viewpoint of the rendering.

A second aspect according to the technique of the present disclosure is an image processing method comprising receiving a setting of a cut section with respect to an organ shown by a three-dimensional image, and enabling to output, as a first display image that is generated by rendering based on the three-dimensional image and shows the organ, a side viewpoint image having a side viewpoint at which the set cut section is viewed from a direction intersecting a normal line of the cut section, set as a viewpoint of the rendering.

A third aspect according to the technique of the present disclosure is a program that causes a computer to execute a process, the process comprising receiving a setting of a cut section with respect to an organ shown by a three-dimensional image, and enabling to output, as a first display image that is generated by rendering based on the three-dimensional image and shows the organ, a side viewpoint image having a side viewpoint at which the set cut section is viewed from a direction intersecting a normal line of the cut section, set as a viewpoint of the rendering.

### BRIEF DESCRIPTION OF THE DRAWINGS

FIG. 1 is a conceptual diagram showing a schematic configuration of a medical service support device.

FIG. 2 is a block diagram showing an example of a hardware configuration of an electric system of the medical service support device.

FIG. 3 is a conceptual diagram showing an example of processing contents of an extraction unit.

FIG. 4 is a conceptual diagram showing an example of processing contents of a display image generation unit.

FIG. 5 is a conceptual diagram showing an example of processing contents of the display image generation unit.

FIG. 6 is a conceptual diagram showing an example of an aspect in which designation of a cut section is received.

FIG. 7 is a conceptual diagram showing an example of an aspect in which an organ image after cutting is displayed on a display device.

FIG. 8 is a conceptual diagram showing an example of processing contents of a viewpoint derivation unit and the display image generation unit.

FIG. 9 is a conceptual diagram showing an example of processing contents of the display image generation unit.

FIG. 10 is a conceptual diagram showing an example of an aspect in which a side viewpoint image and a cross section image are displayed on the display device.

FIG. 11 is a schematic view showing an example of an aspect in which surgery using a laparoscope is performed.

FIG. 12 is a conceptual diagram showing an example of an aspect in which the side viewpoint image and the cross section image are updated.

FIG. 13 is a flowchart illustrating an example of a flow of image processing.

FIG. 14 is a flowchart illustrating an example of a flow of image processing.

FIG. 15 is a conceptual diagram showing an example of an aspect in which the side viewpoint image and the cross section image are displayed on the display device.

FIG. 16 is a conceptual diagram showing an example of an aspect in which the side viewpoint image and the cross section image are updated.

FIG. 17 is a schematic view showing an example of an aspect in which surgery using the laparoscope is performed.

FIG. 18 is a conceptual diagram showing an example of processing contents of the viewpoint derivation unit.

FIG. 19 is a conceptual diagram showing an example of processing contents of the viewpoint derivation unit.

FIG. 20 is a conceptual diagram showing an example of processing contents of the viewpoint derivation unit.

FIG. 21 is a conceptual diagram showing an example of processing contents of the viewpoint derivation unit and the display image generation unit.

FIG. 22 is a conceptual diagram showing an example of processing contents of the viewpoint derivation unit and the display image generation unit.

FIG. 23 is a conceptual diagram showing a schematic configuration of a medical service support system.

### DESCRIPTION OF THE PREFERRED EMBODIMENTS

An example of an embodiment of an image processing device, an image processing method, and a program according to the technique of the present disclosure will be described with reference to the accompanying drawings.

### First Embodiment

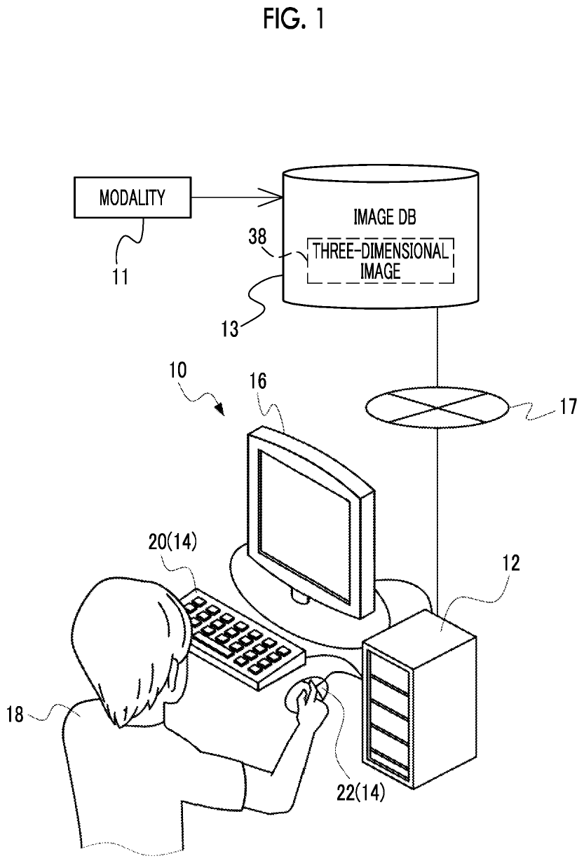

As shown in FIG. 1 as an example, a medical service support device 10 comprises an image processing device 12, a reception device 14, and a display device 16, and is used by a user 18. Here, the user 18 is a user of the medical service support device 10, and examples of the user 18 include a physician and/or a technician. Examples of the user of the medical service support device 10 include an operator of the reception device 14, or a target person whose management information, such as a user ID and a password, is held in the medical service support device 10 and who has a user ID having logged in to the medical service support device 10 through log-in processing of performing authorization based on information input through the reception device 14 and the management information.

The medical service support device 10 is used to perform planning including a simulation of surgery contents prior to actual surgery, for example. Surgery is endoscopic surgery as an example, and more specifically, laparoscopic surgery. In performing a simulation of laparoscopic surgery, a three-dimensional image 38 of the inside of a body of a subject person is acquired by a modality 11, such as a magnetic resonance imaging (MRI) apparatus, in advance. The modality 11 that acquires the three-dimensional image 38 may be a computed tomography (CT) apparatus or an ultrasound apparatus. The three-dimensional image 38 is stored in an image database 13. The medical service support device 10 is connected to the image database 13 through a network 17, acquires the three-dimensional image 38 from the image database 13, and provides a simulation environment of surgery contents to the user 18 based on the three-dimensional image 38.

The reception device 14 is connected to the image processing device 12. The reception device 14 receives an instruction from the user 18. The reception device 14 has a keyboard 20, a mouse 22, and the like. The instruction received by the reception device 14 is acquired by a processor 24. The keyboard 20 and the mouse 22 shown in FIG. 1 are merely an example. As the reception device 14, any one of the keyboard 20 or the mouse 22 may be provided. As the reception device 14, for example, at least one of an approach input device that receives an approach input, a voice input device that receives a voice input, or a gesture input device that receives a gesture input may be applied instead of the keyboard 20 and/or the mouse 22. The approach input device is, for example, a touch panel, a tablet, or the like.

The display device 16 is connected to the image processing device 12. Examples of the display device 16 include an electro-luminescence (EL) display and a liquid crystal display. The display device 16 displays various kinds of information (for example, an image, text, and the like) under the control of the image processing device 12.

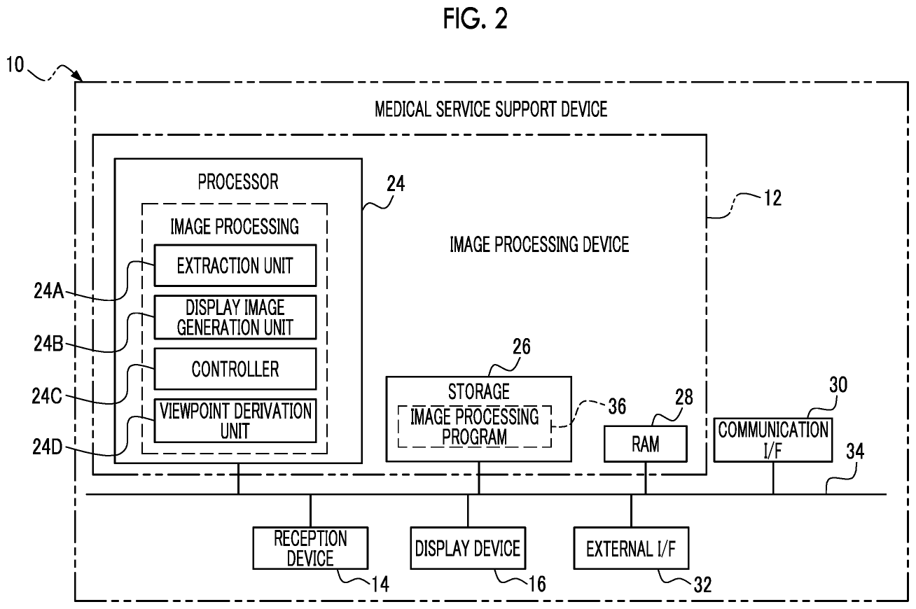

As shown in FIG. 2 as an example, the medical service support device 10 comprises a communication interface (I/F) 30, an external I/F 32, and a bus 34, in addition to the image processing device 12, the reception device 14, and the display device 16.

The image processing device 12 comprises a processor 24, a storage 26, and a random access memory (RAM) 28. The processor 24, the storage 26, the RAM 28, the communication I/F 30, and the external I/F 32 are connected to the bus 34. The image processing device 12 is an example of an “image processing device” and a “computer” according to the technique of the present disclosure, and the processor 24 is an example of a “processor” according to the technique of the present disclosure.

A memory is connected to the processor 24. The memory includes the storage 26 and the RAM 28. The processor 24 has, for example, a central processing unit (CPU) and a graphics processing unit (GPU). The GPU operates under the control of the CPU and is responsible for execution of processing regarding an image.

The storage 26 is a nonvolatile storage device that stores various programs, various parameters, and the like. Examples of the storage 26 include a flash memory (for example, an electrically erasable and programmable read only memory (EEPROM) or a solid state drive (SSD)) and/or a hard disk drive (HDD). A flash memory and an HDD are merely an example, and at least one of a flash memory, an HDD, a magnetoresistive memory, or a ferroelectric memory may be used as the storage 26.

The RAM 28 is a memory in which information is temporarily stored and is used as a work memory by the processor 24. Examples of the RAM 28 include a dynamic random access memory (DRAM) and a static random access memory (SRAM).

The communication I/F 30 is connected to a network (not shown). The network may be configured with at least one of a local area network (LAN) or a wide area network (WAN). An external device (not shown) and the like are connected to the network, and the communication I/F 30 controls transfer of information with an external communication apparatus through the network. The external communication apparatus may include at least one of, for example, a CT apparatus, an MRI apparatus, a personal computer, or a smart device. For example, the communication I/F 30 transmits information according to a request from the processor 24 to the external communication apparatus through the network. The communication I/F 30 receives information transmitted from the external communication apparatus and outputs the received information to the processor 24 through the bus 34.

The external I/F 32 controls transfer of various kinds of information with an external device (not shown) outside the medical service support device 10. The external device may be, for example, at least one of a smart device, a personal computer, a server, a universal serial bus (USB) memory, a memory card, or a printer. An example of the external I/F 32 is a USB interface. The external device is connected directly or indirectly to the USB interface.

An image processing program 36 is stored in the storage 26. The image processing program 36 is a program for providing an environment of a simulation of surgery contents based on the three-dimensional image 38. The processor 24 reads out the image processing program 36 from the storage 26 and executes the read-out image processing program 36 on the RAM 28 to execute image processing. The image processing is realized by the processor 24 operating as an extraction unit 24A, a display image generation unit 24B, a controller 24C, and a viewpoint derivation unit 24D. The extraction unit 24A extracts an image of an organ to be a target of the simulation from the three-dimensional image 38. The display image generation unit 24B generates a display image to be displayed on the display device 16, such as a rendering image 46 or a cross section image 57 described below, based on the three-dimensional image 38. The viewpoint derivation unit 24D derives a viewpoint in performing rendering for projecting the three-dimensional image 38 onto a projection plane. The image processing program 36 is an example of a “program” according to the technique of the present disclosure.

In a case where an ablation simulation of surgery for ablating a malignant tumor, such as cancer, from an organ, for example, in laparoscopic surgery is performed as the simulation of the surgery contents, an appropriate way of cutting an ablation part is examined using a three-dimensional organ model generated from the three-dimensional image 38. As examination contents, in addition to the presence or absence of an influence on the surroundings of an organ to be ablated, the presence or absence of an influence on internal organs inside the organ to be ablated is examined.

Though details will be described below, in an ablation simulation in this way, there is a prospective of interest, and a side viewpoint at which a cut section is viewed from a side is highly frequently used as a viewpoint for viewing the ablation part. Here, the side viewpoint refers to a viewpoint at which the ablation part is viewed from a visual line direction intersecting a normal line of the cut section. An internal organ is included inside an organ, for example, like a case where there is a pancreatic duct inside a pancreas, and the side viewpoint of the cut section is useful for confirming an internal organ present in the cut section of the organ.

To display a side viewpoint image that is an image obtained by viewing the ablation part from the side viewpoint, hitherto, the user needs to manually perform a detailed setting of a viewpoint while confirming a position of a set ablation part, and there is room for improvement from the prospective of usability. Accordingly, the technique of the present disclosure enables to confirm the side viewpoint image of the cut section with a simple operation. Hereinafter, a series of processing of generating a side viewpoint image of an organ to be ablated based on three-dimensional image 38 will be described.

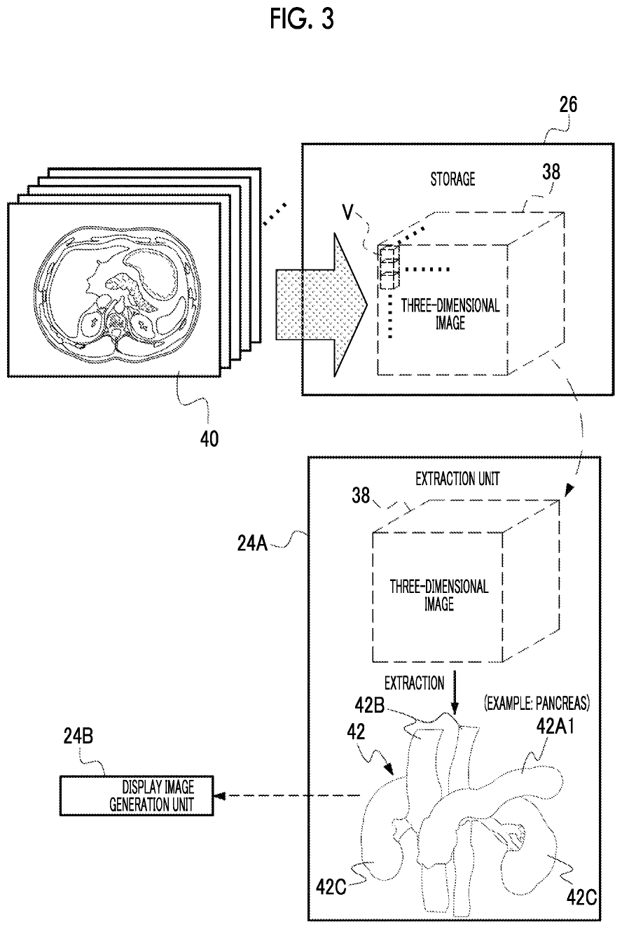

As shown in FIG. 3 as an example, the three-dimensional image 38 acquired from the image database 13 is stored in the storage 26. The three-dimensional image 38 is volume data in which a plurality of two-dimensional slice images 40 are piled, and is composed of a plurality of voxels V as a unit of a three-dimensional pixel. In the example shown in FIG. 3, although two-dimensional slice images of a transverse plane (that is, an axial cross section) are shown as the two-dimensional slice images 40, the technique of the present disclosure is not limited thereto, and two-dimensional slice images of a coronal plane (that is, a coronal cross section) can also be extracted and two-dimensional slice images of a sagittal plane (that is, a sagittal cross section) can also be extracted, from the three-dimensional image 38. A position of each of all voxels V that define the three-dimensional image 38 is specified by three-dimensional coordinates. Each voxel V of the three-dimensional image 38 is given, for example, a unique identifier of each organ, and opacity and color information of red (R), green (G), and blue (B) are set in the identifier of each organ (hereinafter, these are referred to as “voxel data”). The opacity and the color information can be suitably changed.

The extraction unit 24A acquires the three-dimensional image 38 from the storage 26 and extracts a three-dimensional organ image 42 from the acquired three-dimensional image 38. The three-dimensional organ image 42 is a three-dimensional image that shows a partial organ including the organ to be ablated. For example, a peculiar identifier is given to each of a plurality of organs in the three-dimensional image 38. The three-dimensional organ image 42 is extracted from the three-dimensional image 38 with designation of the partial organ including the organ to be ablated by the reception device 14. For example, the extraction unit 24A extracts the three-dimensional organ image 42 corresponding to an identifier received by the reception device 14, from the three-dimensional image 38. In the example shown in FIG. 3, an image 42A1 showing a pancreas is shown as an example of the three-dimensional organ image 42. In the three-dimensional organ image 42, an image 42B showing a blood vessel adjacent to the pancreas and an image 42C showing a kidney are included. The three-dimensional organ image 42 is an example of a “three-dimensional image” according to the technique of the present disclosure.

Here, although the image 42A1 showing the pancreas and the images showing the peripheral organ and the blood vessel are shown as an example of the three-dimensional organ image 42, these are merely an example, and images showing other organs, such as a liver, a heart, and/or a lung, may be employed. A method for extracting the three-dimensional organ image 42 using the peculiar identifier is merely an example, and a method in which a region of the three-dimensional image 38 designated by the user 18 through the reception device 14 is extracted as the three-dimensional organ image 42 by the extraction unit 24A may be employed or a method in which the three-dimensional organ image 42 is extracted by the extraction unit 24A using image recognition processing by an artificial intelligence (AI) system and/or a pattern matching system may be employed.

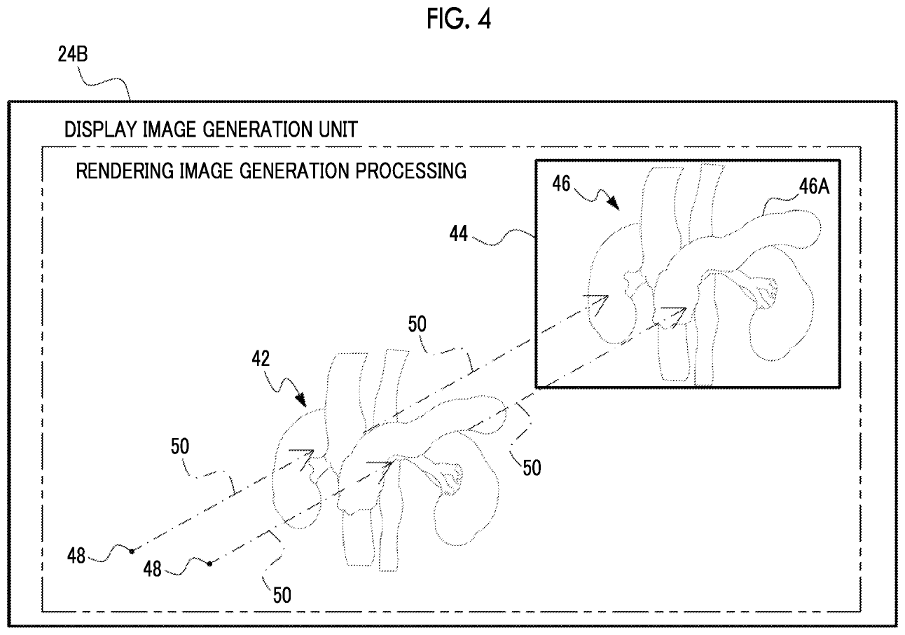

As shown in FIG. 4 as an example, the display image generation unit 24B executes rendering image generation processing. The display image generation unit 24B performs ray casting to perform rendering for projecting the three-dimensional organ image 42 onto a projection plane 44. A projection image projected onto the projection plane 44 is referred to as the rendering image 46. Because a screen of the display device 16 is two-dimensional, such rendering is performed in displaying the three-dimensional image 38 on the screen of the display device 16.

FIG. 4 is a schematic view illustrating rendering. The projection plane 44 is a virtual plane defined with a resolution set in advance. In rendering, a viewpoint 48 for viewing the three-dimensional organ image 42 is set, and the display image generation unit 24B generates the rendering image 46 based on the set viewpoint 48. FIG. 4 shows a parallel projection method. In the parallel projection method, ray casting for projecting a plurality of virtual rays 50 onto the three-dimensional organ image 42 from a plurality of viewpoints 48 set within a plane parallel to the projection plane 44 is performed, whereby pixel values corresponding to voxel data on a plurality of rays 50 are projected onto the projection plane 44, and the rendering image 46 as a projection image is obtained. Each pixel (that is, pixel) of the projection plane 44 has a pixel value corresponding to voxel data on each ray 50. While there are a plurality of pieces of voxel data on the ray 50 passing through the three-dimensional organ image 42, for example, in a case of projecting a surface of the three-dimensional organ image 42, the pixel value corresponding to voxel data of the surface of the three-dimensional organ image 42 intersecting the ray 50 is projected onto the projection plane 44. In the rendering image 46, in a case of showing the set cut section in the three-dimensional organ image 42, the pixel value corresponding to the voxel data of the surface of the set cut section is projected onto the projection plane 44.

A position of each viewpoint 48 with respect to the three-dimensional organ image 42 is changed, for example, in response to an instruction received by the reception device 14, and accordingly, the rendering image 46 in a case of observing the three-dimensional organ image 42 from various directions is projected onto the projection plane 44. The rendering image 46 projected onto the projection plane 44 is displayed on the display device 16 or is stored in a predetermined storage device (for example, the storage 26), for example. Here, although the example of rendering by the parallel projection method has been illustrated, this is merely an example, and for example, rendering by a perspective projection method for projecting a plurality of rays radially from one viewpoint may be performed. In rendering, in addition to simple conversion of the three-dimensional image into a two-dimensional image, shading processing of applying shading or the like may be executed.

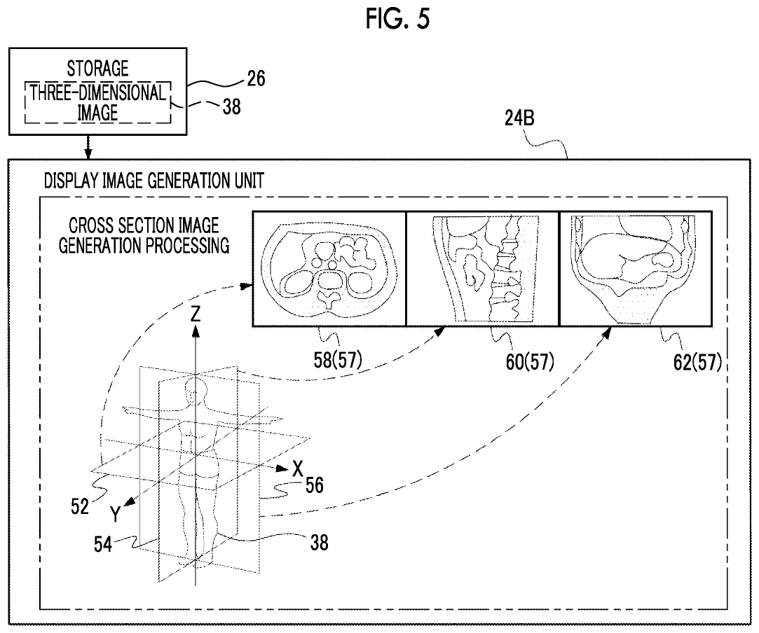

As shown in FIG. 5 as an example, the display image generation unit 24B executes cross section image generation processing, in addition to the rendering image generation processing. The display image generation unit 24B generates a cross section image 57 from the three-dimensional image 38. The display image generation unit 24B acquires a plurality of pixels (that is, pixels) composing any cross section designated in the three-dimensional image 38. The display image generation unit 24B generates the cross section image 57 from pixel values in any cross section of the three-dimensional image 38. For example, in a case where a cross section including a target organ to be ablated is designated as a cross section, the display image generation unit 24B generates the cross section image 57 showing the cross section including the target organ.

In the example shown in FIG. 5, as a cross section of a subject, an axial cross section 52 in which the Z axis as a body axis is a normal direction, a sagittal cross section 54 that is a cross section perpendicular to the axial cross section 52 and along a front-rear direction of the subject, and a coronal cross section 56 that is a cross section perpendicular to the axial cross section 52 and along a right-left direction of the subject are shown. As the cross section image 57, an axial cross section image 58 corresponding to the axial cross section 52, a sagittal cross section image 60 corresponding to the sagittal cross section 54, and a coronal cross section image 62 corresponding to the coronal cross section 56 are shown. The axial cross section 52 is an example of an “axial cross section” according to the technique of the present disclosure, the sagittal cross section 54 is an example of a “sagittal cross section” according to the technique of the present disclosure, and the coronal cross section 56 is an example of a “coronal cross section” according to the technique of the present disclosure. In the example shown in FIG. 5, although a human body is illustrated as the subject, the technique of the present disclosure is not limited thereto, and the subject may be other animals, such as a dog and a cat.

In the following description, a body axis direction is shown by an arrow Z, an arrow Z direction indicated by the arrow Z is referred to as an up direction, and an opposite direction thereto is referred to as a down direction. A width direction is shown by an arrow X perpendicular to the arrow Z, a direction indicated by the arrow X is referred to as a left direction, and an opposite direction thereto is referred to as a right direction. The front-rear direction is indicated by an arrow Y perpendicular to the arrow Z and the arrow X, and a direction indicated by the arrow Y is referred to as a front direction and an opposite direction thereto is referred to as a rear direction. That is, a head side in the human body is the up direction, and a leg side as a side opposite thereto is the down direction. An abdomen side in the human body is the front direction, and a back side opposite thereto is the rear direction. Hereinafter, expressions using a side, such as an upside, a downside, a left side, a right side, a front side, and a rear side have the same meanings as expressions using the direction.

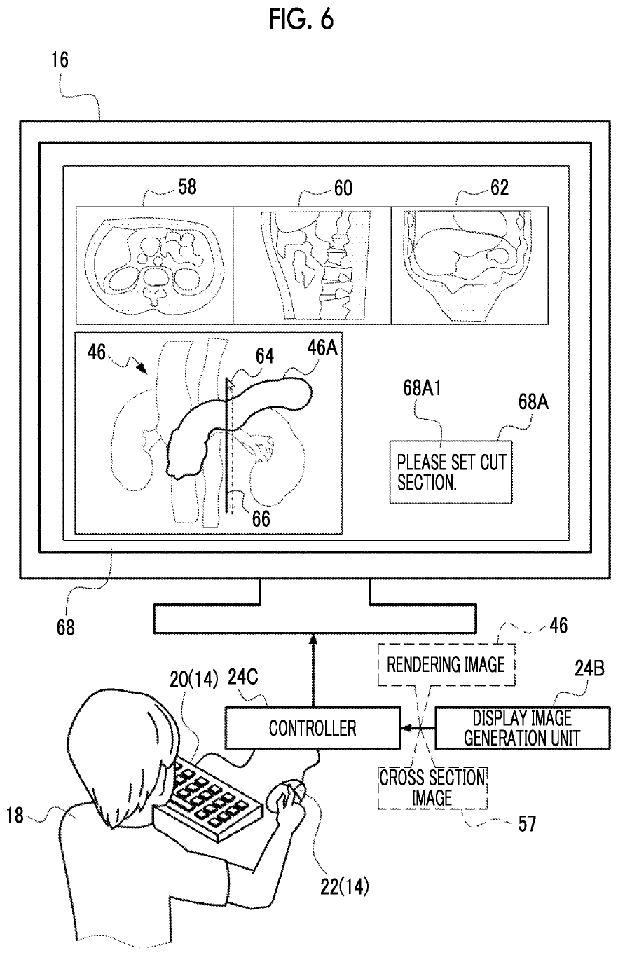

As shown in FIG. 6 as an example, the controller 24C acquires the rendering image 46 before cutting and the cross section image 57 from the display image generation unit 24B. The controller 24C outputs information for displaying the rendering image 46 before cutting and the cross section image 57 on the display device 16. Specifically, the controller 24C performs graphical user interface (GUI) control for displaying the rendering image 46 before cutting and the cross section image 57 to display a screen 68 on the display device 16.

In the example shown in FIG. 6, on the screen 68, the axial cross section image 58, the sagittal cross section image 60, and the coronal cross section image 62 are displayed as the cross section image 57 in an upper portion of the screen. The rendering image 46 before cutting is displayed on a lower left side of the screen 68. Here, as an initial rendering image 46 before cutting, a rendering image 46 before cutting in a case where the three-dimensional organ image 42 is viewed from the front side is displayed.

A guide message display region 68A is displayed on a lower right side of the screen 68. A guide message 68A1 is displayed in the guide message display region 68A. The guide message 68A1 is a message for guiding the user 18 to a setting of the cut section with respect to the three-dimensional organ image 42 through the rendering image 46 before cutting. In the example shown in FIG. 6, as an example of the guide message 68A1, a message “PLEASE SET CUT SECTION.” is shown.

A pointer 64 is displayed on the screen 68. The user 18 operates the pointer 64 through the reception device 14 (here, as an example, the mouse 22) to form a line 66 indicating a cut section with respect to the rendering image 46 before cutting. In the example shown in FIG. 6, the pointer 64 is operated, so that the linear line 66 is formed with respect to the rendering image 46 before cutting. Here, the cut section is set with respect to an image 46A showing a pancreas. The cut section formed with respect to the rendering image 46 before cutting is confirmed in response to an instruction received by the reception device 14. The controller 24C converts position information of the cut section set through the rendering image 46 before cutting into position information of the three-dimensional organ image 42 and sets the cut section with respect to the three-dimensional organ image 42. Through such an operation and processing, the controller 24C receives a setting of a virtual cut section with respect to the organ shown by the three-dimensional organ image 42.

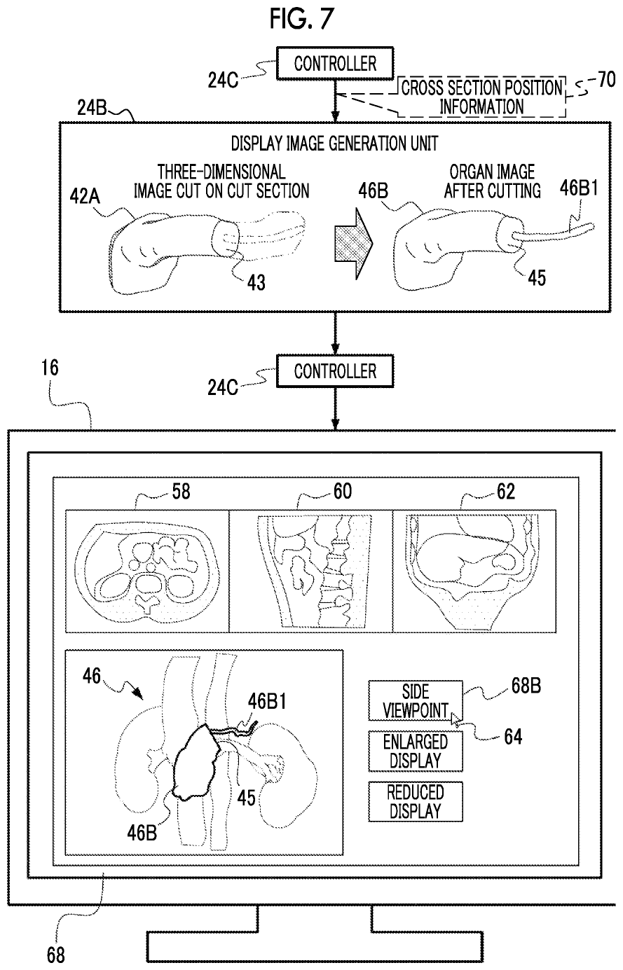

In a case where the setting of the cut section ends, as shown in FIG. 7 as an example, cross section position information 70 that is information indicating position coordinates of the cut section is output to the display image generation unit 24B by the controller 24C. The display image generation unit 24B generates a three-dimensional organ image 42A with the target organ cut on a cut section 43 indicated by the cross section position information 70. In the example shown in FIG. 7, an example where the three-dimensional organ image 42A showing a pancreas is cut on the cut section 43 is shown. The display image generation unit 24B generates a rendering image 46 after cutting from the three-dimensional organ image 42A after cutting. In the rendering image 46 after cutting, a cut section 45 is shown an image 46B (hereinafter, also simply referred to as a “cut pancreas image 46B”) showing a cut pancreas. The cut pancreas image 46B includes an image 46B1 (hereinafter, also simply referred to as a “pancreatic duct image 46B1”) showing a pancreatic duct. In the present embodiment, although the three-dimensional organ image 42A after cutting is a three-dimensional organ image excluding tissues other than a specific tissue (for example, a pancreatic duct) composing the organ from the three-dimensional organ image 42 before cutting, this is merely an example. The specific tissue that remains in the three-dimensional organ image 42A after cutting may be a blood vessel or the like. In regard to the specific tissue, after the setting of the cut section ends, a tissue included in the cut section or within a predetermined range from the cut section may be extracted. The specific tissue may be designated by the user or may be managed as a table in which a specific tissue is associated with each organ, to which the setting of the cut section is to be performed, in advance. In the three-dimensional organ image 42A after cutting, all tissues that are cut from the three-dimensional organ image 42 before cutting may be removed. Although the three-dimensional organ image 42A after cutting is the three-dimensional organ image 42 excluding the tissues other than the specific tissue, transmittance of the tissues other than the specific tissue in rendering may be increased relatively to transmittance of the specific tissue.

The display image generation unit 24B outputs information indicating the rendering image 46 after cutting including the cut pancreas image 46B to the controller 24C. The controller 24C causes the display device 16 to update the screen 68. With this, in the rendering image 46 after cutting, the cut pancreas image 46B is displayed. The controller 24C displays a side viewpoint key 68B on the screen 68. The side viewpoint key 68B is a soft key for switching an initial viewpoint (for example, a viewpoint viewed from the front side) in the rendering image 46 after cutting to a side viewpoint. In other words, the side viewpoint key 68B is a soft key that receives an instruction to create a rendering image 46 (a side viewpoint image 47 described below) at the side viewpoint. The user 18 turns on the side viewpoint key 68B through the reception device 14 (here, as an example, the mouse 22). The rendering image 46 after cutting is an example of a “first display image” according to the technique of the present disclosure.

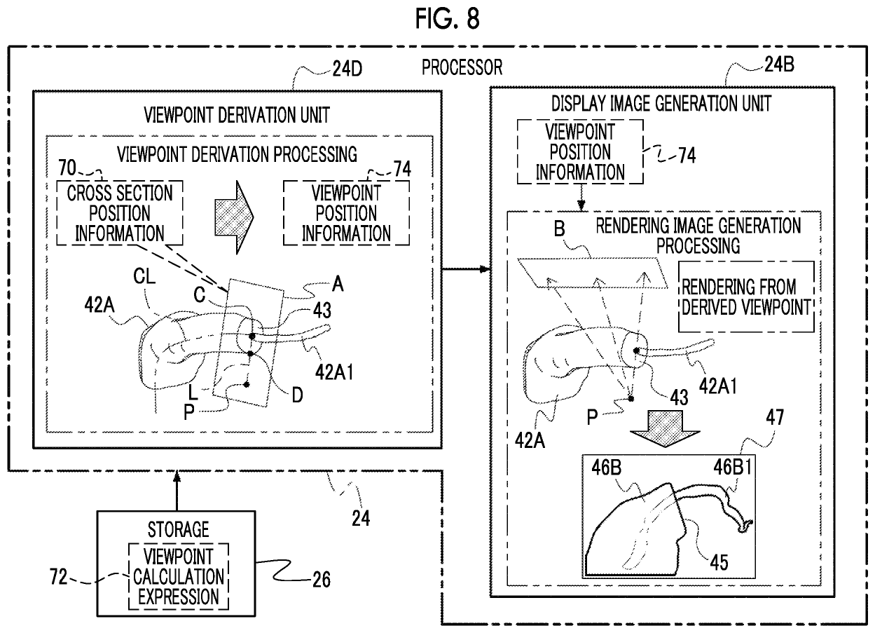

In a case where the side viewpoint key 68B is turned on, as shown in FIG. 8 as an example, the viewpoint derivation unit 24D executes viewpoint derivation processing. The viewpoint derivation processing is processing of deriving a viewpoint at which the cut section 43 is viewed from a side (that is, a direction intersecting a normal direction of the cut section 43). The viewpoint derivation unit 24D derives a viewpoint position P based on the cross section position information 70. The viewpoint position P is, for example, a point that is included in a plane A including the cut section 43. The viewpoint position P is obtained as follows as an example. The viewpoint position P is positioned on a straight line L that connects a point D positioned in coordinates on most downside in position coordinates of the cut section 43 and a center point C of the cut section 43. The center point C is, for example, an intersection of a center line CL obtained by executing thinning processing on the three-dimensional organ image 42 and the plane A. Here, the thinning processing is processing of virtually thinning the three-dimensional organ image 42 into one line. The viewpoint position P is set to a position at a distance determined in advance from the point D on the straight line L. In this case, although a direction of a visual line from the viewpoint position P is a direction of viewing the center point C along the straight line L, this is merely an example. For example, the direction of the visual line may be a body axis direction and a direction of viewing the cut section 43. The center line CL may be obtained by executing the thinning processing on the three-dimensional organ image 42A after cutting after the setting of the cut section.

In a case where there are a plurality of points D (that is, in a case where there are a plurality of lowest points in the cut section 43), a point D at a shortest distance from the center point C may be selected, and a straight line L that connects the center point C and the point D may be set. The side viewpoint image 47 having the side viewpoint set with the center point C of the cut section 43 as a reference is generated, whereby the cut section 43 can be displayed at the center in the side viewpoint image 47. In another example, in a case where there are a plurality of points D, a point D at a longest distance from the center point C may be selected, and a straight line L that connects the center point C and the point D may be set. With this, to bring the entire cut section 43 within the side viewpoint image 47, the side viewpoint position P is moved in a direction away from the cut section 43 (that is, zoomed out). Thus, it is possible to reduce a region of the organ outside a range of an angle of view of the side viewpoint image 47.

The viewpoint derivation unit 24D acquires the position coordinates of the cut section 43 indicated by the cross section position information 70. Then, the viewpoint derivation unit 24D acquires a viewpoint calculation expression 72 from the storage 26. The viewpoint calculation expression 72 is a calculation expression having the position coordinates of the cut section 43 as an independent variable and has position coordinates of the viewpoint position P as a dependent variable. The viewpoint derivation unit 24D derives the position coordinates of the viewpoint position P based on the cross section position information 70 using the viewpoint calculation expression 72. The viewpoint derivation unit 24D outputs a derivation result as viewpoint position information 74 to the display image generation unit 24B.

Here, although a form example where the viewpoint calculation expression 72 is used to derive the position coordinates of the viewpoint position P has been described, the technique of the present disclosure is not limited thereto. For example, instead of the viewpoint calculation expression 72, a viewpoint derivation table may be used to derive the position coordinates of the viewpoint position P. The viewpoint derivation table is a table that has the position coordinates of the cut section 43 as an input value and has the position coordinates of the viewpoint position P as an output value.

The display image generation unit 24B generates the rendering image 46 (that is, the side viewpoint image 47) in a case of being viewed from the side viewpoint by executing the rendering image generation processing based on the viewpoint position information 74. The display image generation unit 24B performs ray casting from the viewpoint position P indicated by the viewpoint position information 74 to render the cut three-dimensional organ image 42A onto a projection plane B. With this, the side viewpoint image 47 is generated. The cut pancreas image 46B and the pancreatic duct image 46B1 are included in the side viewpoint image 47. The side viewpoint image 47 is, for example, an image obtained by viewing the cut section 45 from the bottom. The side viewpoint image 47 is an example of a “side viewpoint image” and a “first display image” according to the technique of the present disclosure.

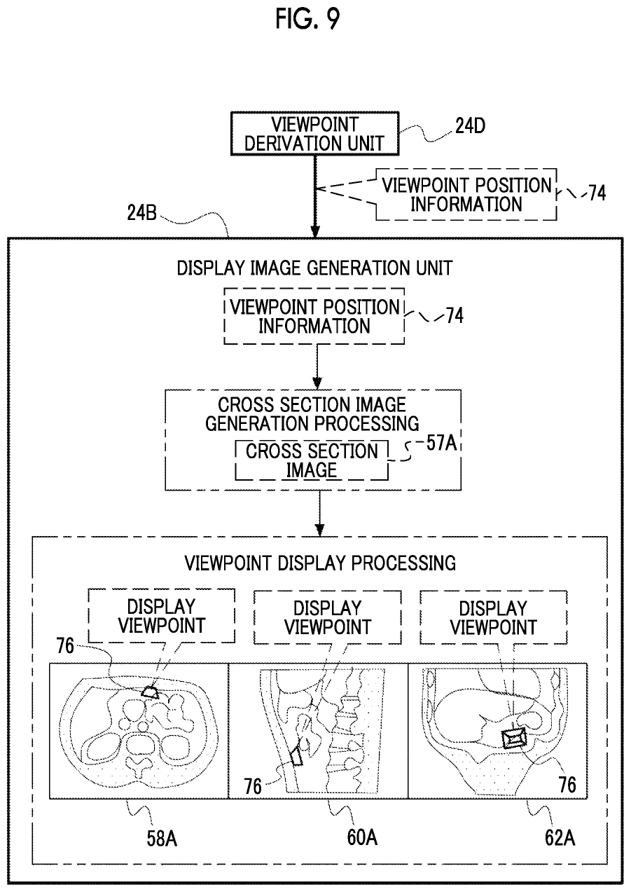

As shown in FIG. 9 as an example, the display image generation unit 24B updates the cross section image 57 by executing the cross section image generation processing based on the viewpoint position information 74 acquired from the viewpoint derivation unit 24D. Specifically, the display image generation unit 24B generates, as a cross section image 57A after update, an axial cross section image 58A, a sagittal cross section image 60A, and a coronal cross section image 62A, in which the position coordinates of the viewpoint position P indicated by the viewpoint position information 74 are included. The display image generation unit 24B executes viewpoint display processing of displaying the viewpoint position P in the cross section image 57A. The display image generation unit 24B displays a viewpoint indicator 76 indicating a position according to the viewpoint position P in the cross section image 57A based on position information of each pixel of the cross section image 57A. In the example shown in FIG. 9, an example where a polygonal figure mark is displayed as the viewpoint indicator 76 is shown. The cross section image 57A is an example of “a cross section image showing a cross section of a human body” according to the technique of the present disclosure. A shape of the viewpoint indicator 76 is not particularly limited, and may be, for example, any of a circle, an asterisk, or a cross shape as long as the viewpoint position can be indicated.

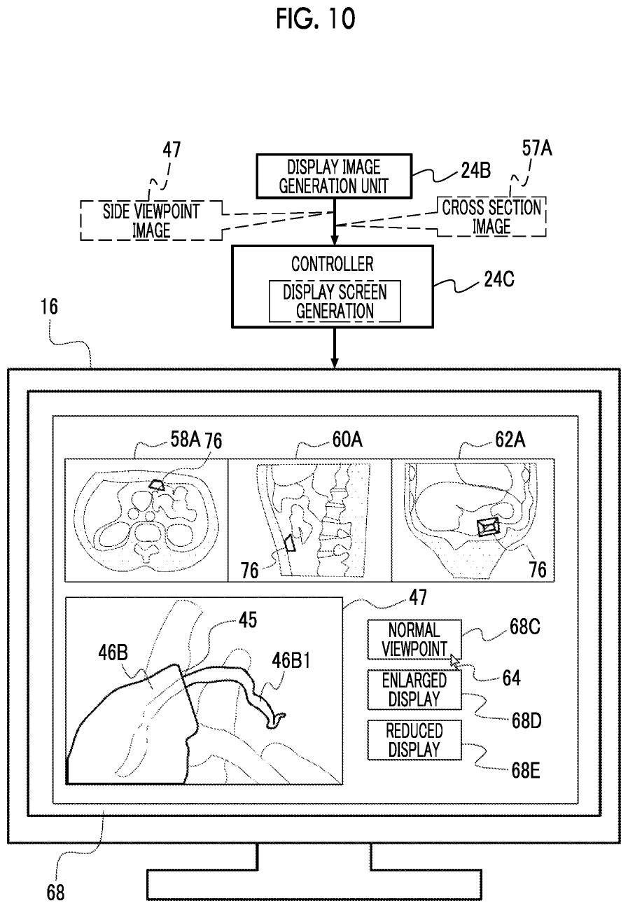

As shown in FIG. 10 as an example, the display image generation unit 24B outputs the side viewpoint image 47 and the cross section image 57A to the controller 24C. The controller 24C generates a screen 68 including the side viewpoint image 47 and the cross section image 57A, and outputs information indicating the screen 68 to the display device 16. Specifically, the controller 24C performs graphical user interface (GUI) control for displaying the side viewpoint image 47 and the cross section image 57A to display the screen 68 on the display device 16. The GUI control is an example of “display control” according to the technique of the present disclosure. The screen 68 is an example of a “display screen” according to the technique of the present disclosure.

In the example shown in FIG. 10, on the screen 68, the axial cross section image 58A, the sagittal cross section image 60A, and the coronal cross section image 62A are displayed as the cross section image 57A in an upper portion of the screen. In each of the axial cross section image 58A, the sagittal cross section image 60A, and the coronal cross section image 62A, the viewpoint indicator 76 is displayed at the position according to the viewpoint position P. The side viewpoint image 47 is displayed on a lower left side of the screen 68. The user can confirm a state in which the cut section 45 is viewed from a side (here, bottom), with the side viewpoint image 47 on the screen 68. The axial cross section image 58A, the sagittal cross section image 60A, and the coronal cross section image 62A are an example of “a plurality of cross section images” according to the technique of the present disclosure.

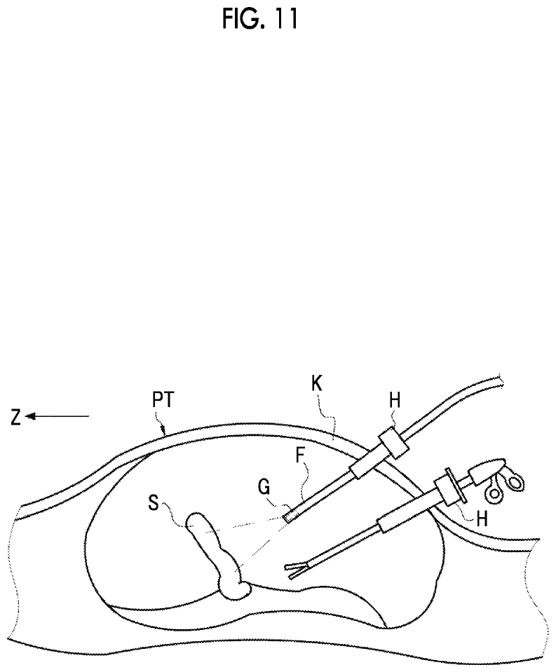

In the example shown in FIG. 10, the cut pancreas image 46B and the pancreatic duct image 46B1 are displayed. For this reason, a manner in which the cut section 43 and the pancreatic duct image 46B1 intersect is easily understood. With this, the user easily ascertains how a pancreatic duct is cut in the cut section 43. As shown in FIG. 11, in surgery using a laparoscope F, the laparoscope F is often inserted through a port H from the bottom of the abdomen K of a patient PT. For this reason, in the surgery using the laparoscope F, surgery is often performed in a state in which a pancreas S is viewed from the bottom, through an operative field camera G mounted in the laparoscope F. Accordingly, in the present embodiment, the side viewpoint image 47 viewed from a downside is displayed, so that an image at a viewpoint close to an appearance in actual surgery can be shown for the user.

A normal viewpoint key 68C is displayed on the screen 68. The normal viewpoint key 68C is a soft key for switching the side viewpoint to an original viewpoint (for example, the initial viewpoint). The user 18 turns on the normal viewpoint key 68C through the reception device 14 (here, as an example, the mouse 22). In a case where the normal viewpoint key 68C is turned on, the controller 24C updates the screen 68 and displays the screen 68 (see FIG. 7) from the initial viewpoint. In this way, the side viewpoint and other viewpoints can be switched on the screen 68 according to an instruction of the user.

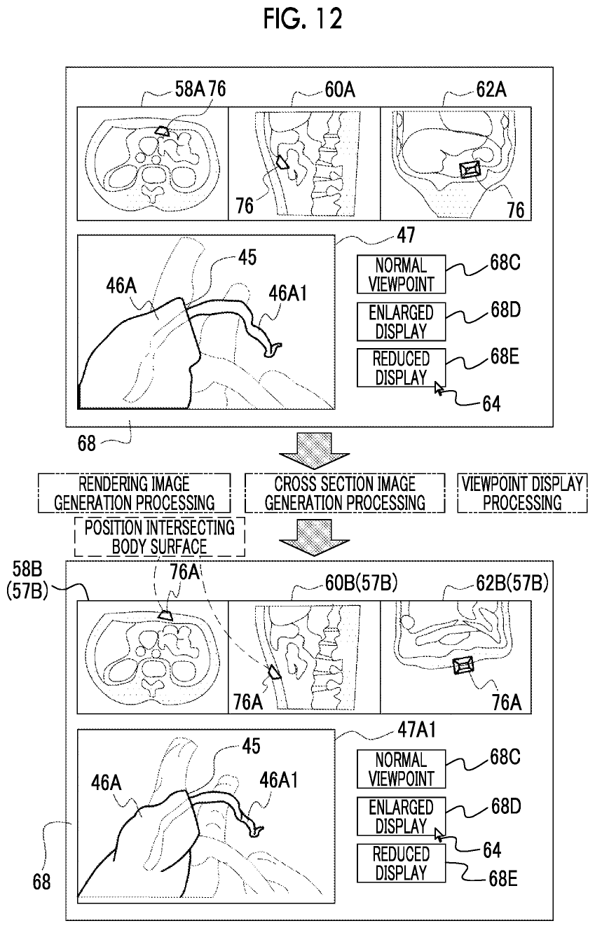

As shown in FIG. 12 as an example, an enlarged display key 68D and a reduced display key 68E are displayed on the screen 68. The enlarged display key 68D is a soft key for enlarging and displaying (that is, zooming in) the side viewpoint image 47. The reduced display key 68E is a soft key for reducing and displaying (that is, zooming out) the side viewpoint image 47. The user 18 turns on the reduced display key 68E through the reception device 14 (here, as an example, the mouse 22). In a case where the reduced display key 68E is turned on, the controller 24C updates the screen 68. Specifically, first, the rendering image generation processing is executed, and the side viewpoint image 47 is updated. In this case, the viewpoint position P is set to a position further away from the cut section 43 than the viewpoint position P before update and ray casting is performed from the viewpoint position P, so that the side viewpoint image 47 is updated. A moving distance of the viewpoint position P may be determined in advance and is, for example, a distance of 1.5 times a distance from the current cut section 43 to the viewpoint position P. The distance from the cut section 43 to the viewpoint position P is derived, for example, as a distance between the center point C of the cut section 43 and the viewpoint position P or a shortest distance between the cut section 43 and the viewpoint position P.

The cross section image generation processing is executed, so that the cross section image 57A is updated. The cross section image 57B after update includes an axial cross section image 58B, a sagittal cross section image 60B, and a coronal cross section image 62B, in which the position coordinates of the viewpoint position P after movement are included. The viewpoint display processing is executed, and a viewpoint indicator 76A is displayed at a position according to the viewpoint position P in the cross section image 57.

Then, a side viewpoint image 47A1 after update and the cross section image 57B after update are displayed on the screen 68. In this way, the viewpoint position P is moved from the cut section 43 toward the body surface side, whereby the cut section 43 can be confirmed in a state in which the viewpoint position P is separated from the cut section 43 and the cut section 43 is zoomed out. In the example shown in FIG. 12, the viewpoint position P is moved to a position where the viewpoint position P intersects the body surface. With such movement of the viewpoint position P, a display position of the viewpoint indicator 76 in the cross section image 57 is also moved, and a position on the body surface where there is the viewpoint position P is displayed. In this way, in the technique of the present disclosure, an intersection position where an extension line (the viewpoint position P of a movement destination by zoom-out is shown as an example) in a visual line direction of the set side viewpoint (the viewpoint of the side viewpoint image 47 before update is shown as an example) and the body surface intersect can be displayed. As described above, in the surgery using the laparoscope F, the laparoscope F is inserted from the body surface. For this reason, the position where the viewpoint position P and the body surface intersect is displayed, so that the user can ascertain an insertion position (that is, a position of the port H) of the laparoscope F to be a current appearance of the side viewpoint image 47. Instead of at least one of the enlarged display key 68D or the reduced display key 68E, a body surface position display key (not shown) for moving the viewpoint position P to the position where the viewpoint position P intersects the body surface in the example shown in FIG. 12 and showing at least one of a side viewpoint image 47A1 updated based on the viewpoint position P or the cross section image 57B after update may be provided. Specifically, in a case where the reception device 14 receives an input of the body surface position display key, the processor 24 acquires body surface information (for example, information indicating position coordinates of the body surface) based on the three-dimensional image 38. Then, the processor 24 derives an intersection position of the extension line in the visual line direction based on the viewpoint position P and the cut section 43 and the position of the body surface indicated by the body surface information. The processor 24 generates the side viewpoint image 47A1 subjected to rendering based on the intersection position and generates the cross section image 57B including the viewpoint indicator 76A indicating the intersection position.

In the present example, an example where the intersection position of the extension line in the visual line direction of the side viewpoint and the body surface is displayed by moving the viewpoint indicator 76 of the cross section image 57 in conjunction with the movement of the viewpoint position P of the side viewpoint image 47 is shown. Note that the display of the intersection position may be not in conjunction with the movement of the viewpoint position P of the side viewpoint image 47. That is, in a case where the side viewpoint of the side viewpoint image 47 before update is set, an intersection position where the extension line of the set side viewpoint and the body surface intersect may be only displayed on the cross section image 57A separately from the set side viewpoint.

The user 18 turns on the enlarged display key 68D through the reception device 14 (here, as an example, the mouse 22). In a case where the enlarged display key 68D is turned on, the controller 24C updates the screen 68. In this case, on the contrary to a case where the reduced display key 68E is turned on, the viewpoint position P is zoomed in to the cut section 43, and the viewpoint position P is set to a position close to the cut section 43. In this state, the rendering image generation processing, the cross section image generation processing, and the viewpoint display processing are executed, and the screen 68 is updated.

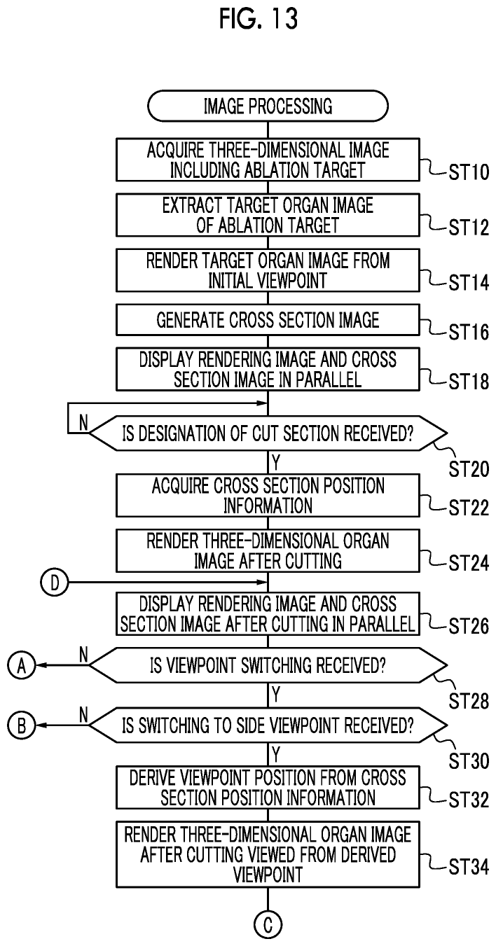

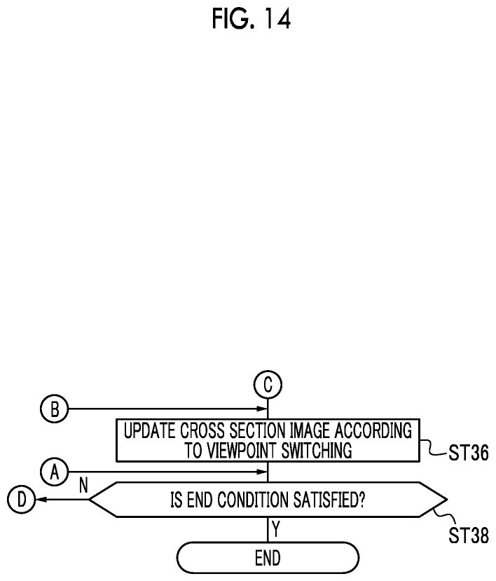

Next, the operations of the medical service support device 10 will be described with reference to FIGS. 13 and 14.

First, an example of a flow of image processing that is executed by the processor 24 of the medical service support device 10 will be described with reference to FIGS. 13 and 14. The flow of the image processing shown in FIGS. 13 and 14 is an example of an “image processing method” according to the technique of the present disclosure.

In the image processing shown in FIG. 13, first, in Step ST10, the extraction unit 24A acquires the three-dimensional image 38 from the storage 26. The three-dimensional image 38 includes an ablation target (for example, pancreas). After the processing of Step ST10 is executed, the image processing proceeds to Step ST12.

In Step ST12, the extraction unit 24A extracts the three-dimensional organ image 42 including the ablation target from the three-dimensional image 38 acquired in Step ST10. After the processing of Step ST12 is executed, the image processing proceeds to Step ST14.

In Step ST14, the display image generation unit 24B renders the three-dimensional organ image 42 extracted in Step ST12 from the initial viewpoint (for example, a viewpoint at which the target organ is viewed from the front). With this, the rendering image 46 is generated. After the processing of Step ST14 is executed, the image processing proceeds to Step ST16.

In Step ST16, the display image generation unit 24B generates the cross section image 57 based on the three-dimensional image 38. Specifically, the axial cross section image 58, the sagittal cross section image 60, and the coronal cross section image 62 including the target organ are generated. After the processing of Step ST16 is executed, the image processing proceeds to Step ST18.

In Step ST18, the controller 24C displays the rendering image 46 generated in Step ST14 and the cross section image 57 generated in Step ST16 on the display device 16 in parallel. After the processing of Step ST18 is executed, the image processing proceeds to Step ST20.

In Step ST20, the controller 24C determines whether or not the designation of the cut section 43 is received through the reception device 14. In Step ST20, in a case where the designation of the cut section 43 is not received, determination is made to be negative, and the processing of Step ST20 is executed again. In Step ST20, in a case where the designation of the cut section 43 is received, determination is made to be affirmative, and the image processing proceeds to Step ST22.

In Step ST22, the controller 24C acquires the cross section position information 70 through the reception device 14. After the processing of Step ST22 is executed, the image processing proceeds to Step ST24.

In Step ST24, the display image generation unit 24B renders the three-dimensional organ image 42A cut on the cut section 43 based on the cross section position information 70 acquired by the controller 24C. With this, the rendering image 46 after cutting including the cut pancreas image 46B is obtained. After the processing of Step ST24 is executed, the image processing proceeds to Step ST26.

In Step ST26, the controller 24C displays the rendering image 46 after cutting including the cut pancreas image 46B and the cross section image 57A after cutting on the display device 16 in parallel. After the processing of Step ST26 is executed, the image processing proceeds to Step ST28.

In Step ST28, the controller 24C determines whether or not viewpoint switching is received through the reception device 14. In Step ST28, in a case where viewpoint switching is not received, determination is made to be negative, and the image processing proceeds to Step ST38. In Step ST28, in a case where viewpoint switching is received, determination is made to be affirmative, and the image processing proceeds to Step ST30.

In Step ST30, the controller 24C determines whether or not switching to the side viewpoint is received through the reception device 14. Step ST30, in a case where switching to the side viewpoint is not received, determination is made to be negative, and the image processing proceeds to Step ST38. In Step ST30, in a case where switching to the side viewpoint is received, determination is made to be affirmative, and the image processing proceeds to Step ST32.

In Step ST32, the viewpoint derivation unit 24D derives the viewpoint position P based on the cross section position information 70 acquired by the controller 24C in Step ST22. After the processing of Step ST32 is executed, the image processing proceeds to Step ST34.

In Step ST34, the display image generation unit 24B renders the three-dimensional organ image 42A viewed from the viewpoint position P and cut on the cut section 43 based on the viewpoint position information 74 indicating the viewpoint position P derived in Step ST32. With this, the side viewpoint image 47 is obtained. After the processing of Step ST34 is executed, the image processing proceeds to Step ST36 shown in FIG. 14.

In Step ST36 shown in FIG. 14, the controller 24C updates the screen 68 according to viewpoint switching. Specifically, the controller 24C switches the side viewpoint image 47 and the rendering image 46 of the normal viewpoint. The controller 24C generates the cross section image 57A according to the viewpoint position P. After the processing of Step ST36 is executed, the image processing proceeds to Step ST38.

In Step ST38, the controller 24C determines whether or not a condition (hereinafter, referred to as an “end condition”) for ending the image processing is satisfied. An example of the end condition is a condition that an instruction to end the image processing is received by the reception device 14. In Step ST38, in a case where the end condition is not satisfied, determination is made to be negative, and the image processing proceeds to Step ST26. In Step ST38, in a case where the end condition is satisfied, determination is made to be affirmative, and the image processing ends.

As described above, with the medical service support device 10 according to the present embodiment, in the processor 24, the setting of the cut section 43 in the three-dimensional organ image 42 is received through the reception device 14, and the side viewpoint image 47 obtained by rendering from the viewpoint position P where the cut section 43 is viewed from the side can be output to the display device 16. In an ablation simulation of an organ, the cut section 43 is set in the three-dimensional organ image 42, and state confirmation of the cut section 43 is performed. In the state confirmation of the cut section 43, a state of a structure (for example, a pancreatic duct in a case where an organ to be ablated is a pancreas) protruding from the cut section 43 is often confirmed. This is because it is generally important to ascertain how the structure is cut by the cut section 43 in an operative method of ablating a part of the organ. In this case, in a case of viewing a protrusion state of the structure, a viewpoint at which the cut section 43 is viewed from the side is useful. This is because a position, an angle, or the like at which the cut section 43 and the structure intersect can be ascertained with the viewpoint of viewing from the side. For this reason, in the ablation simulation, the cut section 43 is frequently viewed from the side viewpoint. Accordingly, in the present configuration, the user can confirm the side viewpoint image 47 of the cut section 43 with a simple operation, compared to a case where the user adjusts a viewpoint with respect to the cut section 43 through trial and error. For example, the side viewpoint key 68B is selected, so that switching to the side viewpoint image 47 of the cut section 43 can be made. Thus, the user can confirm the side viewpoint image 47 with a simple operation.

With the medical service support device 10 according to the present embodiment, in the processor 24, the cross section image 57A is generated, and in the cross section image 57A, the viewpoint indicator 76 is displayed at the position according to the viewpoint position P in the side viewpoint image 47. The processor 24 can output the side viewpoint image 47 and the cross section image 57A to the display device 16. The processor 24 performs the GUI control for displaying the side viewpoint image 47 and the cross section image 57A on the display device 16 in parallel. With this, because the viewpoint position P is displayed in the cross section image 57A, it is possible to ascertain a direction from which the cut section 43 is viewed, for a viewpoint as the viewpoint of the side viewpoint image 47. Displaying in parallel indicates displaying at the substantially same timing in terms of a time axis, and is not intended to limit a layout on the display screen. The side viewpoint image 47 and a plurality of cross section images 57A may be disposed in different sizes on one display screen as in the present embodiment or the display screen may be divided into four parts and the side viewpoint image 47 and any of a plurality of cross section images 57A may be disposed in the same column and the same row. A plurality of display devices may be used, the side viewpoint image 47 may be displayed on one display screen, and the cross section image 57A may be displayed on another display screen.

For example, the ablation simulation is performed while taking into consideration the position of the laparoscope F that captures an operative field image in actual ablation corresponding to the set cut section 43. For this reason, the viewpoint indicator 76 is displayed at the position according to the viewpoint position P of the side viewpoint image 47 in the cross section image 57A, so that it becomes easy to perform determination regarding whether or not imaging can be performed by the laparoscope F, or the like.

With the medical service support device 10 according to the present embodiment, the position of the viewpoint is displayed in the axial cross section image 58A, the sagittal cross section image 60A, and the coronal cross section image 62A as the cross section image 57A. Thus, the viewpoint of the side viewpoint image 47 is ascertained in a three-dimensional manner and it is easy to ascertain a direction from which the cut section 43 is viewed for the viewpoint, compared to a case where the number of cross section images 57A is one.

With the medical service support device 10 according to the present embodiment, the position where the body surface and the viewpoint indicator 76 intersect is displayed in the cross section image 57B. As described above, in the surgery using the laparoscope F, the laparoscope F is inserted from the port H set in the abdomen K of the patient PT. The position where the body surface and the viewpoint indicator 76 intersect is displayed, so that it becomes easy to determine whether or not the viewpoint position P set according to the cut section 43 can be set as the insertion position of the laparoscope F. For example, even though a certain side viewpoint is set in the cut section 43, in a case where the intersection position of the body surface and the viewpoint indicator 76 is a position where it is difficult to set the port H, the user can determine to examine another side viewpoint.

With the medical service support device 10 according to the present embodiment, in the processor 24, in a case where the viewpoint position P is changed in the side viewpoint image 47 on the screen 68, the position of the viewpoint indicator 76A in the cross section image 57B after change is changed in conjunction. In this way, the position of the viewpoint indicator 76A in the cross section image 57 and the position of the viewpoint position P where the cut section 45 is viewed, in the side viewpoint image 47 are changed in conjunction. For this reason, for example, even in a case where the viewpoint position P of the side viewpoint image 47 is changed, it is easy to ascertain a direction from which the cut section 43 is viewed inside the body.

With the medical service support device 10 according to the present embodiment, it is possible to switch the side viewpoint image 47 and the rendering image 46 viewed from the normal viewpoint (for example, the viewpoint at which the three-dimensional organ image 42A is viewed from the front side). With this, switching to the rendering image 46 from a viewpoint different from the side viewpoint image 47 is performed, so that it is possible to display an image (for example, an image in which the entire organ is shown) for use in examination other than the suitability of the cut section 43. For example, in the present embodiment, the normal viewpoint key 68C is selected, so that it is possible to perform switching the rendering image 46 of the cut section 43. Thus, the user can confirm the rendering image 46 with a simple operation.

In the above-described first embodiment, although a form example where the viewpoint at which the three-dimensional organ image 42A after cutting is viewed from the front is set as the initial viewpoint after the setting of the cut section 43 is received has been described, the technique of the present disclosure is not limited thereto. For example, a viewpoint from the rear may be set as the initial viewpoint or a viewpoint set in advance by the user may be employed. An initial viewpoint position P may be set as follows. That is, a viewpoint table in which an initial viewpoint is associated with each organ may be used, and after an organ to be ablated is selected by the user or the organ to be ablated is specified from the three-dimensional image 38 by image processing, the initial viewpoint position may be set based on organ information of the organ to be ablated and the viewpoint table.

In the above-described first embodiment, although a form example where, after the setting of the cut section 43 is received, the rendering image 46 after cutting viewed from the initial viewpoint is displayed, and switching to the side viewpoint image 47 is performed according to the instruction of the user has been described, the technique of the present disclosure is not limited thereto. For example, a form may be made in which the side viewpoint image 47 is displayed after the setting of the cut section 43 is received.

In the above-described first embodiment, although a form example where the enlarged display key 68D or the reduced display key 68E is selected in a case of moving the viewpoint position P of the side viewpoint image 47 has been described, the technique of the present disclosure is not limited thereto. For example, a slider for adjusting the position of the viewpoint position P may be displayed, instead of the enlarged display key 68D and the reduced display key 68E, and a position of the slider may be adjusted through the pointer 64, so that the position of the viewpoint position P may be adjusted. In a case where the mouse 22 as the reception device 14 comprises a wheel, the adjustment of the viewpoint position P may be performed according to the rotation of the wheel.

In the above-described first embodiment, although a form example where the position of the viewpoint indicator 76 displayed in the cross section image 57 is also interlocked with the movement of the viewpoint position P of the side viewpoint image 47 has been described, the technique of the present disclosure is not limited thereto. For example, the viewpoint position P of the side viewpoint image 47 may also be changed in conjunction with change in the position of the viewpoint indicator 76.

In the above-described first embodiment, although a form example where the viewpoint position P is set to the position at the distance determined in advance from the point D on the straight line L has been described, the technique of the present disclosure is not limited thereto. For example, the viewpoint position P may be set to a position at a distance determined in advance from the point D in a body axis direction.

In the above-described first embodiment, although a form example where the straight line L passes through the center point C has been described, the technique of the present disclosure is not limited thereto. For example, the straight line L may be a straight line that passes through a center of gravity of the three-dimensional organ image 42A.

In the above-described first embodiment, although a form example where the viewpoint position P is positioned on the straight line L has been described, the technique of the present disclosure is not limited thereto. For example, a point of coordinates positioned on a most downside on a boundary line at a distance determined in advance from an outer edge of the cut section 43 may be set as the viewpoint position P.

In the above-described first embodiment, although the medical service support device 10 generates the cross section image 57 and displays the rendering image 46 and the cross section image 57 in parallel before the designation of the cut section 43 is received, it is not necessary to generate and display the cross section image 57. The medical service support device 10 may display only the rendering image 46 without generating the cross section image 57, for example, before the designation of the cut section 43 is received, and may receive the designation of the cut section 43 with respect to the rendering image 46.

In the above-described first embodiment, although a form example where the medical service support device 10 generates the cross section image 57 before the designation of the cut section 43 is received, and displays the rendering image 46 after cutting and the cross section image 57 in parallel after the designation of the cut section 43 is received has been described, the technique of the present disclosure is not limited thereto. The medical service support device 10 may generate the cross section image 57 or may display only the rendering image 46 after cutting without generating the cross section image 57, after the designation of the cut section 43 is received.

In the above-described first embodiment, although a form example where the medical service support device 10 generates the cross section image 57 before switching to the side viewpoint is received, and updates and displays the side viewpoint image 47 and the cross section image 57A including the side viewpoint after switching to the side viewpoint is received has been described, the technique of the present disclosure is not limited thereto. The medical service support device 10 may generate the cross section image 57A including the side viewpoint or may display only the side viewpoint image 47 without generating the cross section image 57A including the side viewpoint, after switching to the side viewpoint is received.

In the above-described first embodiment, although a case where the three cross section images of the axial cross section image 58A, the sagittal cross section image 60A, and the coronal cross section image 62A are displayed as the cross section image 57A has been illustrated, the technique of the present disclosure is not particularly limited thereto. At least one of the axial cross section image 58A, the sagittal cross section image 60A, or the coronal cross section image 62A may be displayed as the cross section image 57A. The same applies to the cross section image 57 and the cross section image 57B.

### Second Embodiment

In the above-described first embodiment, although a form example where the viewpoint at which the cut section 43 is viewed from the bottom is set as the side viewpoint has been described, the technique of the present disclosure is not limited thereto. In a present second embodiment, a viewpoint (that is, top viewpoint) at which the cut section 43 is viewed from the top and a viewpoint (that is, bottom viewpoint) at which the cut section 43 is viewed from the bottom can be set as the side viewpoint, and the top viewpoint and the bottom viewpoint can be switched.

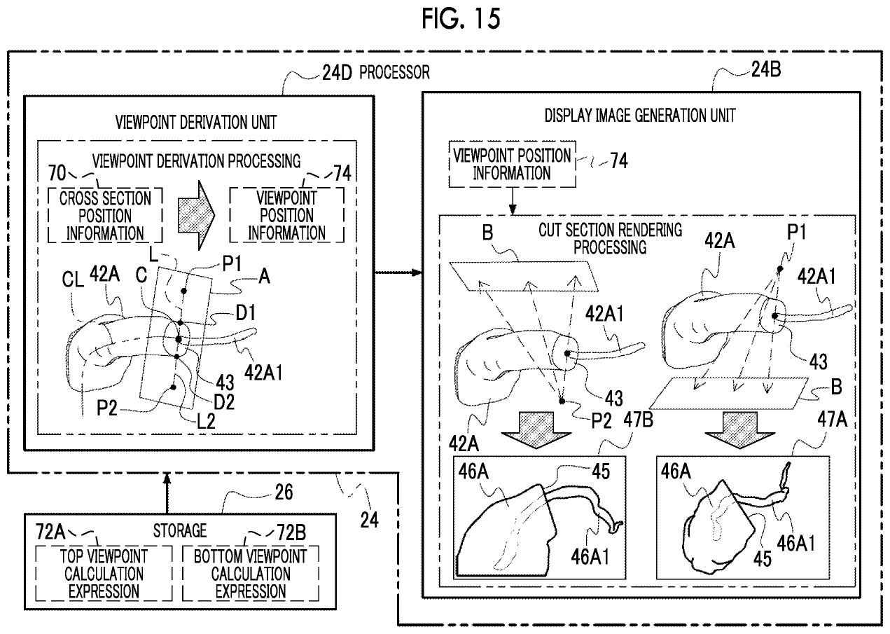

As shown in FIG. 15 as an example, the viewpoint derivation unit 24D derives a viewpoint position P1 (hereinafter, also simply referred to as a “top viewpoint position P1”) of the top viewpoint and a viewpoint position P2 (hereinafter, also simply referred to as a “bottom viewpoint position P2”) of the bottom viewpoint based on the cross section position information 70.

The top viewpoint position P1 is obtained as follows, for example. The top viewpoint position P1 is positioned on a straight line L1 that connects a point D1 positioned in coordinates on a most upside in the position coordinates of the cut section 43 and the center point C of the cut section 43. The bottom viewpoint position P2 is positioned on a straight line L2 that connects a point D2 positioned in coordinates on a most downside in the position coordinates of the cut section 43 and the center point C of the cut section 43. A method of obtaining the top viewpoint position P1 and the bottom viewpoint position P2 is merely an example, and an aspect may be made in which the top viewpoint position P1 and the bottom viewpoint position P2 are positioned on the straight line L1 or L2 on opposite sides with the center point C interposed therebetween. The center point C is an example of a “reference point” according to the technique of the present disclosure, and the straight line L is an example of a “reference line” according to the technique of the present disclosure.

Specifically, the viewpoint derivation unit 24D acquires a top viewpoint calculation expression 72A and a bottom viewpoint calculation expression 72B from the storage 26. The top viewpoint calculation expression 72A is a calculation expression that has the position coordinates of the cut section 43 as an independent variable and has position coordinates of the top viewpoint position P1 as a dependent variable. The bottom viewpoint calculation expression 72B is a calculation expression that has the position coordinates of the cut section 43 as an independent variable and position coordinates of the bottom viewpoint position P2 as a dependent variable. The viewpoint derivation unit 24D derives the top viewpoint position P1 based on the cross section position information 70 using the top viewpoint calculation expression 72A. The viewpoint derivation unit 24D derives the bottom viewpoint position P2 based on the cross section position information 70 using the bottom viewpoint calculation expression 72B.

Instead of the top viewpoint calculation expression 72A and the bottom viewpoint calculation expression 72B, a top viewpoint derivation table and a bottom viewpoint derivation table may be used to obtain the top viewpoint position P1 and the bottom viewpoint position P2. The top viewpoint derivation table is a table that has the position coordinates of the cut section 43 as an input value and has the position coordinates of the top viewpoint position P1 as an output value. The bottom viewpoint derivation table is a table that has the position coordinates of the cut section 43 as an input value and has the position coordinates of the bottom viewpoint position P2 as an output value.

The viewpoint derivation unit 24D outputs viewpoint position information 74 indicating the position coordinates of the top viewpoint position P1 and the bottom viewpoint position P2 to the display image generation unit 24B. The display image generation unit 24B generates a top viewpoint image 47A that is an image obtained by viewing the three-dimensional organ image 42A from the top viewpoint position P1. The display image generation unit 24B generates a bottom viewpoint image 47B that is an image obtained by viewing the three-dimensional organ image 42A from the bottom viewpoint position P2. The display image generation unit 24B outputs the top viewpoint image 47A and the bottom viewpoint image 47B to the controller 24C.

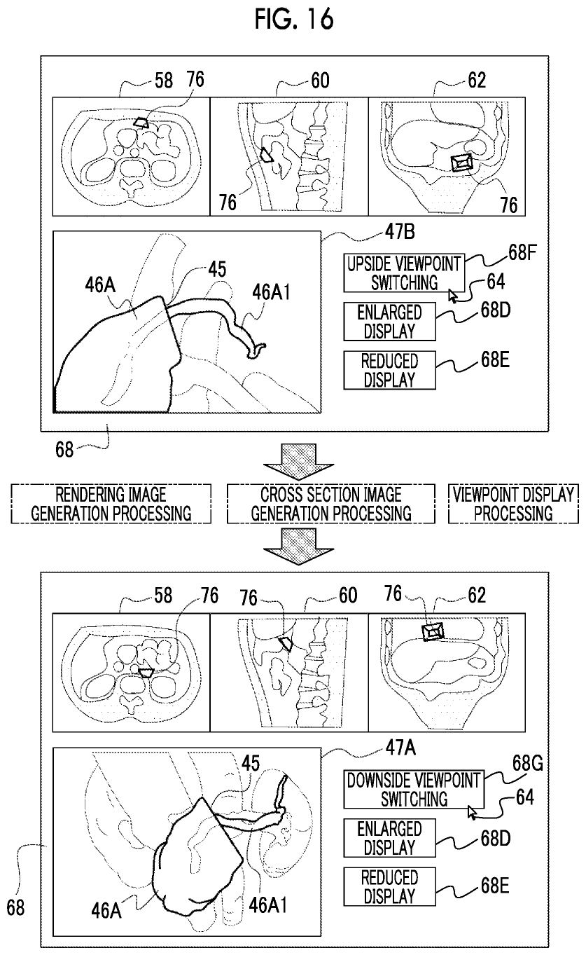

In a case where the side viewpoint key 68B (see FIG. 7) is selected by the user, switching to the side viewpoint is performed. As shown in FIG. 16 as an example, in this case, the bottom viewpoint image 47B is displayed on the screen 68 under the control of the controller 24C (see FIG. 7 and the like). That is, an initial position of the side viewpoint is the bottom viewpoint position P2. The cross section image 57 in which the viewpoint indicator 76 is disposed at a position corresponding to the bottom viewpoint position P2 is displayed. An upside viewpoint switching key 68F is displayed on the screen 68. In a case where the upside viewpoint switching key 68F is selected by the user through the pointer 64, the bottom viewpoint image 47B is switched to the top viewpoint image 47A. The cross section image 57 in which the viewpoint indicator 76 is disposed at a position corresponding to the top viewpoint position P1 is displayed. The downside viewpoint switching key 68G is displayed on the screen 68. In a case where the downside viewpoint switching key 68G is selected by the user through the pointer 64, the top viewpoint image 47A is switched to the bottom viewpoint image 47B. In this way, the user can switch the top viewpoint position P1 and the bottom viewpoint position P2 as the side viewpoint, and the top viewpoint image 47A and the bottom viewpoint image 47B are displayed on the screen 68 according to switching. The top viewpoint image 47A is an example of a “first side viewpoint image” according to the technique of the present disclosure, and the bottom viewpoint image 47B is an example of a “second side viewpoint image” according to the technique of the present disclosure. The top viewpoint image 47A and the bottom viewpoint image 47B are an example of a “first display image” and “a plurality of side viewpoint images” according to the technique of the present disclosure.

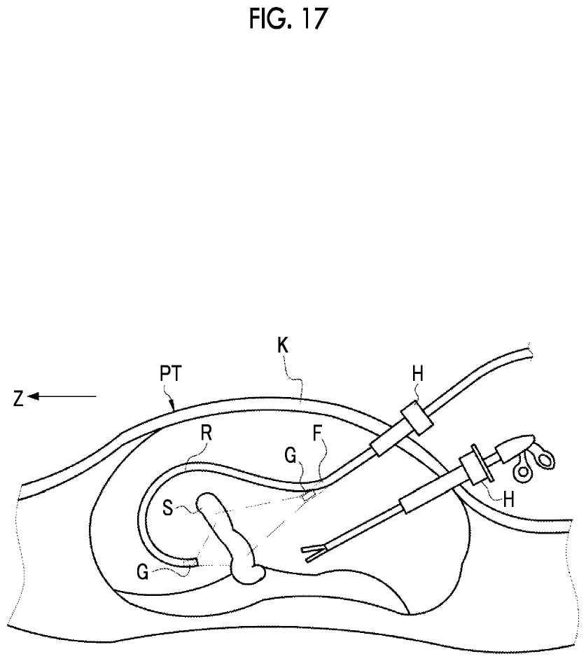

As shown in FIG. 17 as an example, in general, the operative field camera G that is mounted in the laparoscope F is often disposed corresponding to two upside and downside viewpoints of an organ (for example, pancreas S) in the body axis direction (that is, the Z axis direction) of the patient PT. In a case where the viewpoint is disposed on the upside, an oblique-viewing endoscope R is used. In this way, in an operative method in a case of cutting an organ, the operative field camera G often views the organ from the upside or the downside of the cut section 43. For this reason, in the present configuration, the top viewpoint position P1 and the bottom viewpoint position P2 can be switched as the side viewpoint, and the top viewpoint image 47A and the bottom viewpoint image 47B are displayed on the screen 68 according to switching.

As described above, with the medical service support device 10 according to the present second embodiment, in the processor 24, the top viewpoint image 47A obtained by viewing the cut section 43 from the upside and the bottom viewpoint image 47B obtained by viewing the cut section 43 from the downside can be output. Accordingly, in the present configuration, because a plurality of side viewpoint images 47 obtained by viewing the cut section 43 in different directions can be switched and displayed, a situation of the cut section 43 is easily confirmed, compared to a case where the number of side viewpoint images 47 is one.

In a case where the cut section 43 indicated by the cross section position information 70 is a plane perpendicular to the body axis direction, all position coordinates in the body axis direction (up-down direction) on the cut section are identical. Thus, because it is not possible to acquire the top viewpoint position P1 and the bottom viewpoint position P2 based on the position coordinates in the body axis direction, position coordinates in the front-rear direction or the right-left direction, instead of the body axis direction, may be used. For example, in a case where the front-rear direction is used, a front viewpoint image 47E having a point E of position coordinates on a most front side as the viewpoint position P and a rear viewpoint image 47F having a point F of position coordinates on a most rear side as the viewpoint position P may be presented instead of the top viewpoint image 47A and the bottom viewpoint image 47B. A point G closest to the center point C on a contour of the cut section may be acquired, a point H across the center point C from the point G may be acquired, and a first viewpoint image 47G having the point G as the viewpoint position P and a second viewpoint image 47H having the point H as the viewpoint position P may be presented instead of the top viewpoint image 47A and the bottom viewpoint image 47B.

With the medical service support device 10 according to the present second embodiment, the top viewpoint image 47A and the bottom viewpoint image 47B are included as the side viewpoint image 47. In general, the operative field camera G that is mounted in the laparoscope F is often disposed corresponding to two upside and downside viewpoints of the cut section 43 in the body axis direction. That is, in an operative method in a case of cutting an organ, the organ is often viewed from the upside or the downside of the cut section 43. Accordingly, in the present configuration, a situation of the cut section 43 is easily confirmed from two actual viewpoints of the operative field camera G even in an ablation simulation.

With the medical service support device 10 according to the present second embodiment, the top viewpoint position P1 and the bottom viewpoint position P2 are set on the straight line L set in the cut section 43. Because the top viewpoint position P1 and the bottom viewpoint position P2 are disposed on opposite sides of the cut section 43 in the straight line L, a positional relationship of the top viewpoint position P1 and the bottom viewpoint position P2 with respect to the cut section 43 is easily ascertained.

With the medical service support device 10 according to the present second embodiment, the bottom viewpoint position P2 is set as an initial position in a case where switching to the side viewpoint is performed. In the surgery using the laparoscope F, in general, the operative field camera G is often disposed on the downside of the target organ and views the target organ from the downside. For this reason, in the ablation simulation, the confirmation of the cut section 43 is often performed using the bottom viewpoint image 47B. In the present configuration, because the bottom viewpoint position P2 is set as the initial position, an image viewed from a viewpoint having a high use frequency is displayed earlier, so that the convenience of the user is improved.

In the above-described second embodiment, although a form example where the bottom viewpoint position P2 is set as the initial position in a case where switching to the side viewpoint is performed has been described, the technique of the present disclosure is not limited thereto. For example, the top viewpoint position P1 may be set as the initial position. That is, in the above-described second embodiment, one of the top viewpoint position P1 and the bottom viewpoint position P2 can be set as the initial position. As described above, in the surgery using the laparoscope F, any viewpoint in a case of viewing the target organ from the upside or in a case of viewing the target organ from the downside is often employed. Accordingly, one of the top viewpoint position P1 and the bottom viewpoint position P2 having a high use frequency is set as the initial position, so that the convenience of the user is improved.

In the above-described second embodiment, although a form example where one of the top viewpoint position P1 and the bottom viewpoint position P2 is set as the initial position has been described, the technique of the present disclosure is not limited thereto. The top viewpoint image 47A based on the top viewpoint position P1 and the bottom viewpoint image 47B based on the bottom viewpoint position P2 may be displayed in parallel. In addition to the top viewpoint image 47A and the bottom viewpoint image 47B, the cross section image 57 in which both the top viewpoint position P1 and the bottom viewpoint position P2 are shown may be displayed in parallel. In displaying the top viewpoint image 47A and the bottom viewpoint image 47B in parallel, in a case where there is a change operation of the viewpoint position, the change operation may be interlocked in the top viewpoint image 47A and the bottom viewpoint image 47B or each viewpoint position may be changeable individually. The interlocking of the change operation is, for example, an aspect in which, in a case where an input of the enlarged display key 68D is received, in both the top viewpoint image 47A and the bottom viewpoint image 47B, the top viewpoint position P1 and the bottom viewpoint position P2 are set such that the cut section 45 in the image is enlarged.

In the above-described second embodiment, although a form example where the two viewpoint positions of the top viewpoint position P1 and the bottom viewpoint position P2 are switchable has been described, the technique of the present disclosure is not limited thereto. Other than the top viewpoint position P1 and the bottom viewpoint position P2, a plurality of viewpoint positions P may be on the side of the cut section 43 and may be switchable.

### First Modification Example

In the above-described first and second embodiments, although a form example where the side viewpoint is set according to the cut section 43 has been described, the technique of the present disclosure is not limited thereto. In a present first modification example, the side viewpoint is set according to an input of the user.

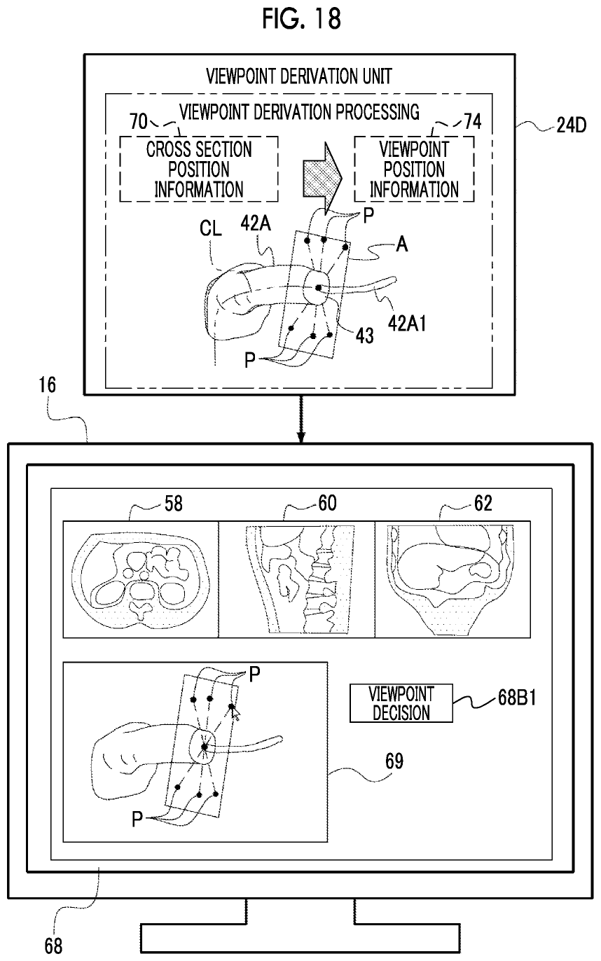

As shown in FIG. 18 as an example, first, the viewpoint derivation unit 24D derives a plurality of viewpoint positions P based on the cross section position information 70. Specifically, the viewpoint derivation unit 24D derives a plurality of positions at a distance determined in advance from the outer edge of the cut section 43 as candidates of the viewpoint position P. In the example shown in FIG. 18, an example where six candidates of the viewpoint position P are derived is shown. The viewpoint derivation unit 24D outputs viewpoint position information 74 indicating position coordinates of a plurality of viewpoint position P to the controller 24C (see FIG. 7 and the like).

An image 69 for deciding the viewpoint position P is displayed on the screen 68 under the control of the controller 24C. In the image 69, candidates of the viewpoint position P with respect to the target organ are shown. The user designates the viewpoint position P from among the candidates of the viewpoint position P through the pointer 64. Then, the user selects a viewpoint decision key 68B1 displayed on the screen 68. As a result, the viewpoint position P is decided, and a side viewpoint image 47 viewed from the designated viewpoint position P is generated. Then, the side viewpoint image 47 is displayed on the screen 68, instead of the image 69.

As described above, in the present first modification example, the side viewpoint is set based on the input of the user. For this reason, the side viewpoint desired by the user is easily set, compared to a case where the side viewpoint is constantly fixed. As a result, the side viewpoint image 47 viewed from a more appropriate viewpoint position P is displayed.

### Second Modification Example

In the above-described first and second embodiments, although a form example where the side viewpoint is set according to the cut section 43 has been described, the technique of the present disclosure is not limited thereto. In a present second modification example, the side viewpoint is set according to conditions input from the user.

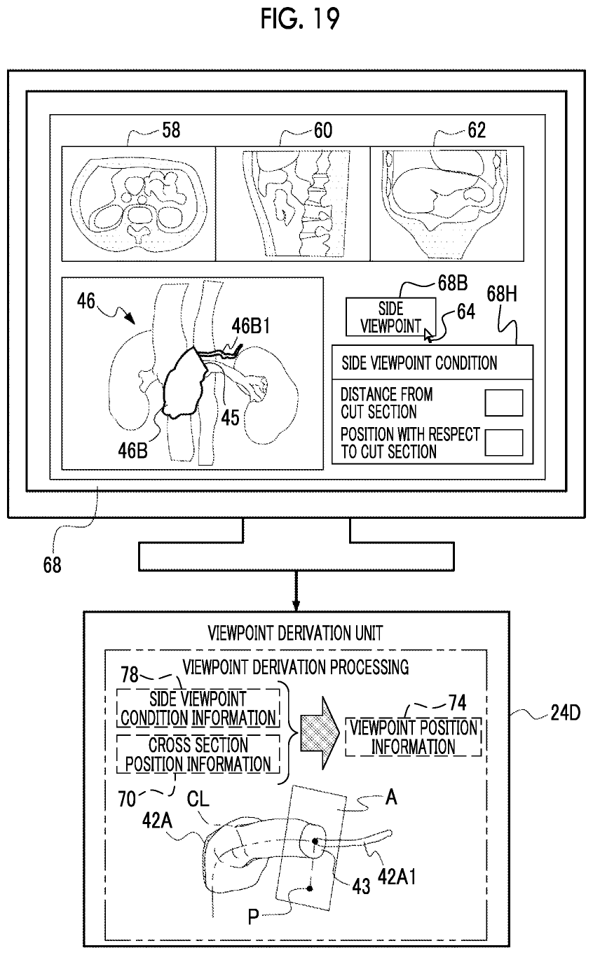

As shown in FIG. 19 as an example, in a case where the side viewpoint key 68B is turned on, a condition input window 68H is displayed. In the condition input window 68H, a message that indicates a condition for designating the side viewpoint is displayed. In the example shown in FIG. 19, messages “distance from cut section” and “position with respect to cut section” are displayed. The user inputs the conditions for designating the side viewpoint through the reception device 14.

The viewpoint derivation unit 24D acquires side viewpoint condition information 78 that is information indicating the conditions for designating the side viewpoint input from the user. The viewpoint derivation unit 24D generates viewpoint position information 74 based on the side viewpoint condition information 78 and the cross section position information 70. Specifically, the viewpoint derivation unit 24D derives a position at a distance indicated by the side viewpoint condition information 78 from the cut section 43, as the viewpoint position P. The viewpoint derivation unit 24D outputs the viewpoint position information 74 to the display image generation unit 24B. With this, in the display image generation unit 24B, a side viewpoint image 47 viewed from the side viewpoint designated by the user is generated.

As described above, in the present second modification example, the side viewpoint is set based on the conditions designated by the user. For this reason, the side viewpoint desired by the user is easily set, compared to a case where the side viewpoint is constantly fixed. As a result, the side viewpoint image 47 viewed from a more appropriate viewpoint position P is displayed.

### Third Modification Example

In the above-described first and second embodiments, although a form example where the side viewpoint is set according to the cut section 43 has been described, the technique of the present disclosure is not limited thereto. In a present third modification example, the side viewpoint is set according to a target organ and an operative method.

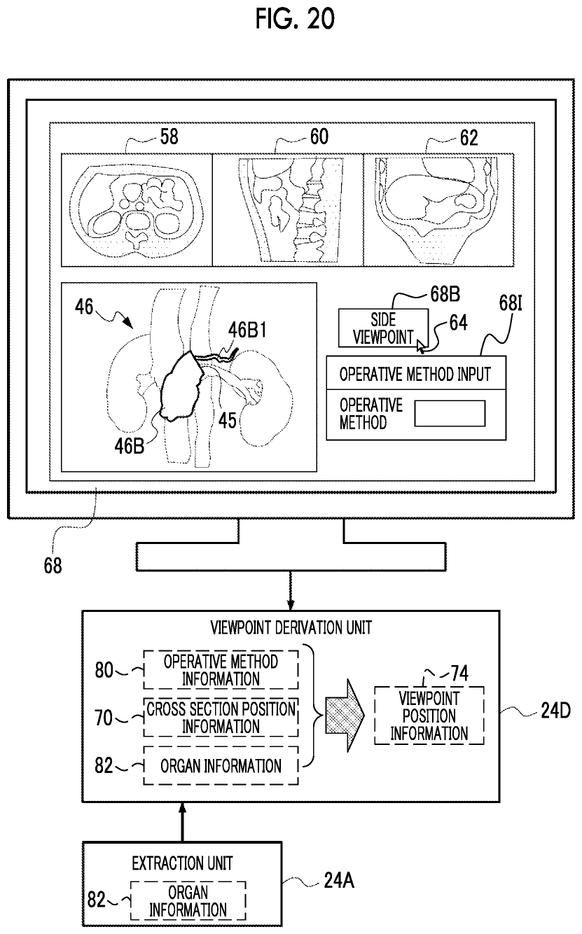

As shown in FIG. 20 as an example, in a case where the side viewpoint key 68B is turned on, an operative method input window 68I is displayed. The user inputs an operative method to be examined in an ablation simulation to the operative method input window 68I through the reception device 14. An example of the operative method is an operative method using an oblique-viewing endoscope R (see FIG. 17).

The viewpoint derivation unit 24D acquires operative method information 80 that is information indicating the operative method. The viewpoint derivation unit 24D acquires organ information 82 that is information indicating the target organ, from the extraction unit 24A. The viewpoint derivation unit 24D generates viewpoint position information 74 based on the operative method information 80, the organ information 82, and the cross section position information 70.

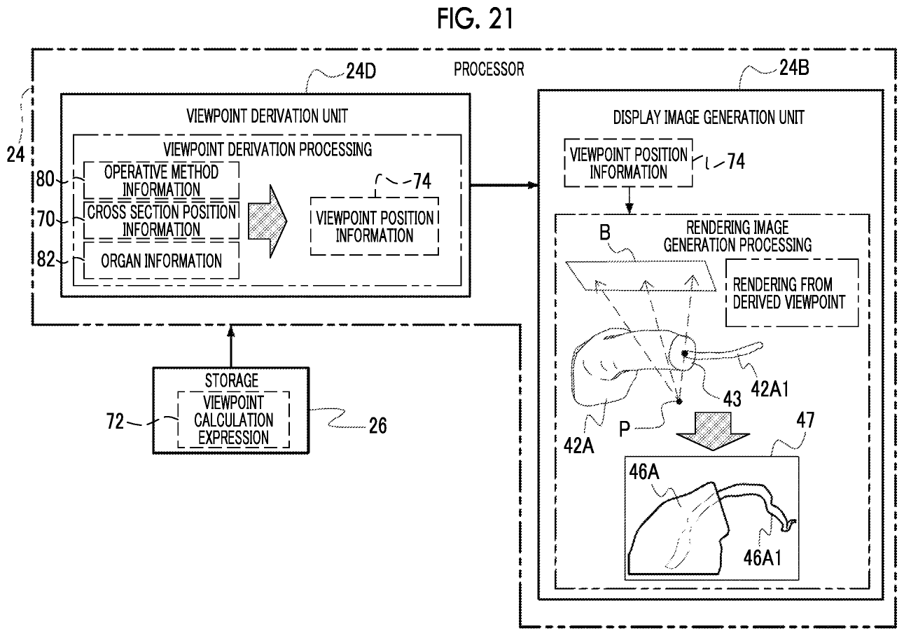

Specifically, as shown in FIG. 21 as an example, the viewpoint derivation unit 24D acquires a viewpoint calculation expression 72 from the storage 26. The viewpoint calculation expression 72 is a calculation expression that has a numerical value according to the operative method, a numerical value according to the organ, and the position coordinates of the cut section 43 as independent variables, and has the position coordinates of the viewpoint position P as a dependent variables. The viewpoint derivation unit 24D derives a viewpoint position P based on the operative method information 80, the organ information 82, and the cross section position information 70 using the viewpoint calculation expression 72. The display image generation unit 24B generates a side viewpoint image 47 viewed from the viewpoint position P indicated by the viewpoint position information 74.

The position coordinates of the viewpoint position P may be obtained using a viewpoint derivation table, instead of the viewpoint calculation expression 72. The viewpoint derivation table is a table that has the numerical value according to the operative method, the numerical value according to the organ, and the position coordinates of the cut section 43 as input values, and has the position coordinates of the viewpoint position P as an output value.

As described above, in the present third modification example, the side viewpoint is set based on the organ information 82 regarding a target of the ablation simulation and the operative method information 80. For this reason, a side viewpoint according to the content of the ablation simulation is easily set, compared to a case where the side viewpoint is constantly fixed. As a result, the side viewpoint image 47 viewed from a more appropriate viewpoint position P is displayed.

In the present third modification example, although a form example where the side viewpoint is set based on the operative method information 80 and the organ information 82 has been described, the technique of the present disclosure is not limited thereto. The side viewpoint may be set based on any of the operative method information 80 or the organ information 82. The side viewpoint may be set based on information according to the input of the user described in the first modification example and the second modification example described above and the operative method information 80 and/or the organ information 82.

### Fourth Modification Example

In the above-described first and second embodiments, although a form example where the side viewpoint image 47 is obtained by rendering the three-dimensional organ image 42A has been described, the technique of the present disclosure is not limited thereto. In a present fourth modification example, optical characteristic reflection processing that is processing of reflecting the optical characteristics of the operative field camera G in the side viewpoint image 47 is executed.

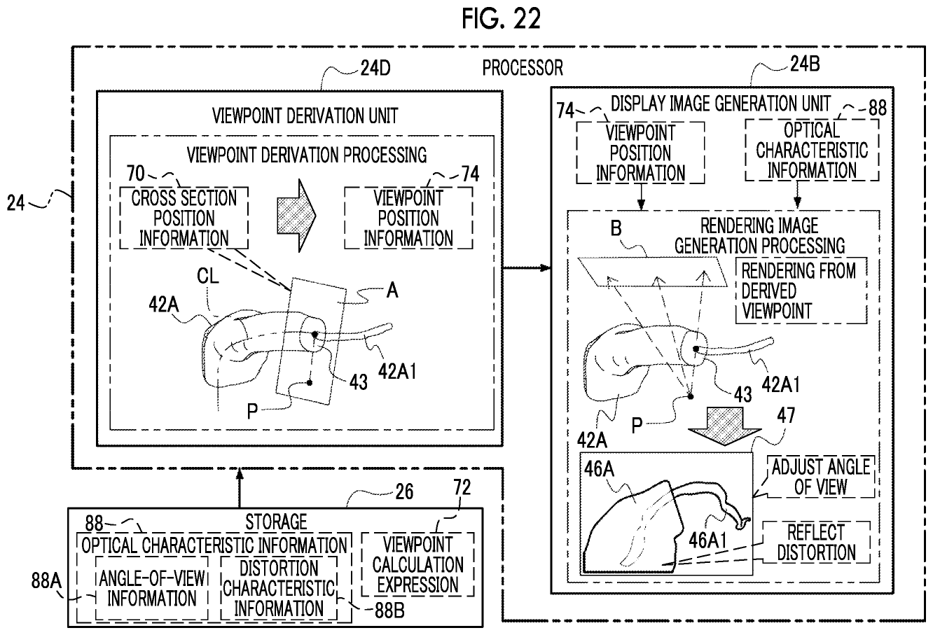

As shown in FIG. 22 as an example, the viewpoint derivation unit 24D generates viewpoint position information 74 based on the cross section position information 70 by executing the viewpoint derivation processing. The display image generation unit 24B renders the three-dimensional organ image 42A based on the viewpoint position information 74 to generate a side viewpoint image 47. The display image generation unit 24B acquires optical characteristic information 88 from the storage 26. The optical characteristic information 88 is information indicating characteristics of an optical system (for example, objective lens) of the operative field camera G The optical characteristic information 88 includes angle-of-view information 88A and distortion characteristic information 88B. The optical characteristic information 88 is an example of “optical characteristic information” according to the technique of the present disclosure.

The angle-of-view information 88A is information indicating an angle of view in the operative field camera G The display image generation unit 24B adjusts an angle of view in the side viewpoint image 47 according to the angle of view indicated by the angle-of-view information 88A. The distortion characteristic information 88B is information indicating distortion that occurs in imaging with the operative field camera G The display image generation unit 24B distorts a peripheral visual field of the side viewpoint image 47 according to distortion indicated by the distortion characteristic information 88B. The display image generation unit 24B outputs the side viewpoint image 47 subjected to the optical characteristic reflection processing.

As described above, in the present fourth modification example, the optical characteristic reflection processing is executed on the side viewpoint image 47. With this, because the characteristic reflection processing of reflecting the optical characteristic of the operative field camera G is executed, it is possible to bring the side viewpoint image 47 for use in the ablation simulation close to an appearance of an actual operative field image.

In the present fourth modification example, the optical characteristic information 88 includes the angle-of-view information 88A and the distortion characteristic information 88B. The optical characteristic reflection processing is processing of performing the adjustment of the angle of view and the reflection of distortion on the side viewpoint image 47. The optical characteristics, such as the distortion characteristic and the angle of view, significantly influence the appearance of the operative field image in the operative field camera G, compared to other optical characteristics, such as chromatic aberration, astigmatism, and coma aberration. Thus, because the optical characteristic reflection processing according to the optical characteristics of the operative field camera G is executed on the side viewpoint image 47, it is possible to bring the side viewpoint image 47 for use in the ablation simulation close to the appearance of the actual operative field image.

In the above-described fourth modification example, although a form example where the optical characteristic reflection processing is executed based on the angle-of-view information 88A and the distortion characteristic information 88B has been described, the technique of the present disclosure is not limited thereto. The optical characteristic reflection processing may be executed based on any of the angle-of-view information 88A or the distortion characteristic information 88B.

In each embodiment described above, although a form example where the viewpoint position P is included in the plane A including the cut section 43 has been described, the technique of the present disclosure is not limited thereto. The viewpoint position P may be at a position where the state (for example, a state of intersection of the structure in the organ and the cut section 45) of the cut section 45 can be confirmed by the side viewpoint image 47, and the viewpoint position P may not be included in the plane A.

In each embodiment described above, although a form example where the image processing is executed by the processor 24 of the image processing device 12 included in the medical service support device 10 has been described, the technique of the present disclosure is not limited thereto, and a device that executes the image processing may be provided outside the medical service support device 10.

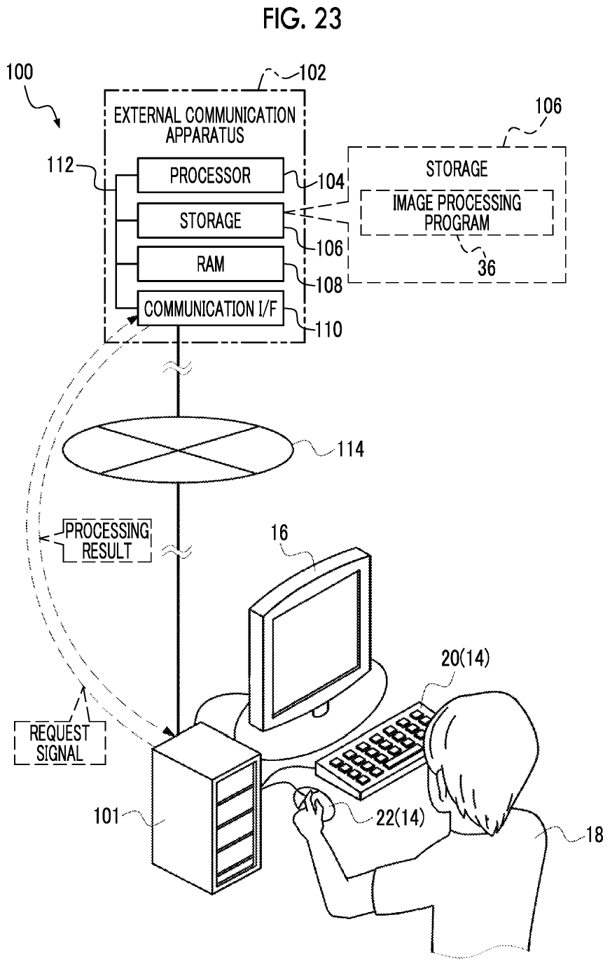

In this case, as shown in FIG. 23 as an example, a medical service support system 100 may be used. The medical service support system 100 comprises an information processing apparatus 101 and an external communication apparatus 102. The information processing apparatus 101 is a device in which the image processing program 36 is removed from the storage 26 of the image processing device 12 that is included in the medical service support device 10 described in the above-described embodiments. The external communication apparatus 102 is, for example, a server. The server is realized by, for example, a main frame. Here, although the main frame has been illustrated, this is merely an example, and the server may be realized by cloud computing or may be realized by network computing, such as fog computing, edge computing, or grid computing. Here, although the server is illustrated as an example of the external communication apparatus 102, this is merely an example, and instead of the server, at least one personal computer or the like may be used as the external communication apparatus 102.

The external communication apparatus 102 comprises a processor 104, a storage 106, a RAM 108, and a communication I/F 110, and the processor 104, the storage 106, the RAM 108, and the communication I/F 110 are connected by a bus 112. The communication I/F 110 is connected to the information processing apparatus 101 through a network 114. The network 114 is, for example, the Internet. The network 114 is not limited to the Internet, and may be a WAN and/or a LAN, such as an intranet.

In the storage 106, the image processing program 36 is stored. The processor 104 executes the image processing program 36 on the RAM 108. The processor 104 executes the above-described image processing following the image processing program 36 that is executed on the RAM 108.

The information processing apparatus 101 transmits a request signal for requesting the execution of the image processing to the external communication apparatus 102. The communication I/F 110 of the external communication apparatus 102 receives the request signal through the network 114. The processor 104 executes the image processing following the image processing program 36 and transmits a processing result to the information processing apparatus 101 through the communication I/F 110. The information processing apparatus 101 receives the processing result (for example, a processing result by the display image generation unit 24B) transmitted from the external communication apparatus 102 with the communication I/F 30 (see FIG. 2) and outputs the received processing result to various devices, such as the display device 16.

In the example shown in FIG. 23, the external communication apparatus 102 is an example of an “image processing device” according to the technique of the present disclosure, and the processor 104 is an example of a “processor” according to the technique of the present disclosure.

The image processing may be distributed to and executed by a plurality of devices including the information processing apparatus 101 and the external communication apparatus 102. In the above-described embodiments, although the three-dimensional image 38 is stored in the storage 26 of the medical service support device 10, an aspect may be made in which the three-dimensional image 38 is stored in the storage 106 of the external communication apparatus 102 and is acquired from the external communication apparatus 102 through the network before the image processing is executed.

In the above-described embodiments, although a form example where the image processing program 36 is stored in the storage 26 has been described, the technique of the present disclosure is not limited thereto. For example, the image processing program 36 may be stored in a storage medium (not shown), such as an SSD or a USB memory. The storage medium is a portable non-transitory computer readable storage medium. The image processing program 36 that is stored in the storage medium is installed on the medical service support device 10. The processor 24 executes the image processing following the image processing program 36.

The image processing program 36 may be stored in a storage device of another computer, a server, or the like connected to the medical service support device 10 through the network, the image processing program 36 may be downloaded according to a request of the medical service support device 10 and may be installed on the medical service support device 10. That is, the program (program product) described in the present embodiment may be provided by a recording medium or may be distributed from an external computer.

The entire image processing program 36 may not be stored in the storage device of another computer, the server, or the like connected to the medical service support device 10 or in the storage 26, and a part of the image processing program 36 may be stored. The storage medium, the storage device of another computer, the server, or the like connected to the medical service support device 10, and other external storages may be placed as a memory that is connected to the processor 24 directly or indirectly and be used.

In the above-described embodiments, although the processor 24, the storage 26, the RAM 28, and the communication I/F 30 of the image processing device 12 are illustrated as a computer, the technique of the present disclosure is not limited thereto, and instead of the computer, a device including an application specific integrated circuit (ASIC), a field-programmable gate array (FPGA), and/or a programmable logic device (PLD) may be applied. Instead of the computer, a combination of a hardware configuration and a software configuration may be used.

As a hardware resource for executing the image processing described in the above-described embodiments, various processors described below can be used. Examples of the processors include a CPU that is a general-purpose processor configured to execute software, that is, the program to function as the hardware resource for executing the image processing. Examples of the processors include a dedicated electric circuit that is a processor, such as an FPGA, a PLD, or an ASIC, having a circuit configuration dedicatedly designed for executing specific processing. A memory is incorporated in or connected to any processor, and any processor uses the memory to execute the image processing.

The hardware resource for executing the image processing may be configured with one of various processors or may be configured with a combination of two or more processors (for example, a combination of a plurality of FPGAs or a combination of a CPU and an FPGA) of the same type or different types. The hardware resource for executing the image processing may be one processor.

As an example where the hardware resource is configured with one processor, first, there is a form in which one processor is configured with a combination of one or more CPUs and software, and the processor functions as the hardware resource for executing the image processing. Second, as represented by System-on-a-chip (SoC) or the like, there is a form in which a processor that realizes all functions of a system including a plurality of hardware resources for executing the image processing into one integrated circuit (IC) chip is used. In this way, the image processing is realized using one or more processors among various processors described above as a hardware resource.

As the hardware structures of various processors, more specifically, an electronic circuit in which circuit elements, such as semiconductor elements, are combined can be used. The above-described image processing is just an example. Accordingly, it goes without saying that unnecessary steps may be deleted, new steps may be added, or a processing order may be changed without departing from the gist.

The content of the above description and the content of the drawings are detailed description of portions according to the technique of the present disclosure, and are merely examples of the technique of the present disclosure. For example, the above description relating to configurations, functions, operations, and advantageous effects is description relating to an example of configurations, functions, operations, and advantageous effects of the portions according to the technique of the present disclosure. Thus, it is needless to say that unnecessary portions may be deleted, new elements may be added, or replacement may be made to the content of the above description and the content of the drawings without departing from the gist of the technique of the present disclosure. Furthermore, to avoid confusion and to facilitate understanding of the portions according to the technique of the present disclosure, description relating to common technical knowledge and the like that does not require particular description to enable implementation of the technique of the present disclosure is omitted from the content of the above description and from the content of the drawings.

In the specification, “A and/or B” is synonymous with “at least one of A or B”. That is, “A and/or B” may refer to A alone, B alone, or a combination of A and B. Furthermore, in the specification, a similar concept to “A and/or B” applies to a case in which three or more matters are expressed by linking the matters with “and/or”.

All cited documents, patent applications, and technical standards described in the specification are incorporated by reference in the specification to the same extent as in a case where each individual cited document, patent application, or technical standard is specifically and individually indicated to be incorporated by reference.

In regard to the above-described embodiment, the following supplementary notes will be further disclosed.

Supplementary Note 1

An image processing device comprising:

a processor,

in which the processor is configured to

receive a setting of a cut section with respect to an organ shown by a three-dimensional image, and

output, as a first display image that is generated by rendering based on the three-dimensional image and shows the organ, a side viewpoint image having a side viewpoint at which the set cut section is viewed from a direction intersecting a normal line of the cut section, set as a viewpoint of the rendering.

Supplementary Note 2

The image processing device according to Supplementary Note 1,

in which the processor is configured to output, as a second display image, a cross section image that shows a cross section of a human body including the organ and on which a position of the viewpoint of the first display image is displayed, and

perform display control for displaying the first display image and the second display image in parallel on a display screen.

Supplementary Note 3

The image processing device according to Supplementary Note 2,

in which the cross section image includes a plurality of cross section images that show respective cross sections of an axial cross section, a coronal cross section, and a sagittal cross section.

Supplementary Note 4

The image processing device according to any one of Supplementary Note 1 to

Supplementary Note 3,

in which the processor is configured to

output a plurality of the side viewpoint images having different viewing directions in surroundings of the cut section, and

switch and display the plurality of side viewpoint images as the first display image displayed on the display screen.

Supplementary Note 5

The image processing device according to Supplementary Note 4,

in which, in a case where a head side in a body axis direction is an upside and an opposite side is a downside,

the plurality of side viewpoint images include at least a first side viewpoint image obtained by viewing the cut section from the upside and a second side viewpoint image obtained by viewing the cut section from the downside.

Supplementary Note 6

The image processing device according to Supplementary Note 5,

in which a first side viewpoint of the first side viewpoint image and a second side viewpoint of the second side viewpoint image are set on a reference line passing through a reference point set in advance within the cut section.

Supplementary Note 7

The image processing device according to Supplementary Note 6,

in which one of the first side viewpoint and the second side viewpoint is settable as an initial position

Supplementary Note 8

The image processing device according to Supplementary Note 7,

in which the second side viewpoint is set as the initial position.

Supplementary Note 9

The image processing device according to any one of Supplementary Note 1 to Supplementary Note 8,

in which an intersection position where an extension line in a visual line direction of the set side viewpoint intersects a body surface is displayable.

Supplementary Note 10

The image processing device according to any one of Supplementary Note 1 to Supplementary Note 9,

in which the side viewpoint is set according to at least one of information based on an input of a user, information regarding the organ, or information regarding an operative method for cutting the organ.

Supplementary Note 11

The image processing device according to any one of Supplementary Note 2 to Supplementary Note 10,

in which the processor is configured to change another viewpoint in conjunction in a case where the viewpoint is changed in one of the first display image and the second display image on the display screen.

Supplementary Note 12

The image processing device according to any one of Supplementary Note 1 to Supplementary Note 11,

in which the processor is configured to

acquire optical characteristic information representing an optical characteristic of a camera, and

execute characteristic reflection processing of reflecting the optical characteristic in the first display image based on the optical characteristic information.

Supplementary Note 13

The image processing device according to Supplementary Note 12,

in which at least one of a distortion characteristic or an angle of view is included in the optical characteristic, and

the characteristic reflection processing is processing of reflecting at least one of the distortion characteristic or the angle of view in the first display image.

Supplementary Note 14

The image processing device according to any one of Supplementary Note 1 to Supplementary Note 13,

in which the first display image is switchable to a viewpoint image obtained by viewing the organ from a viewpoint different from the side viewpoint.

### EXPLANATION OF REFERENCES

10: medical service support device
11: modality
13: image database
12: image processing device
14: reception device
16: display device
17: network
18: user
20: keyboard
22: mouse
24: processor
24A: extraction unit
24B: display image generation unit
24C: controller
24D: viewpoint derivation unit
26: storage
28: RAM
30: communication OF
32: external OF
34: bus
36: image processing program
38: three-dimensional image
40: two-dimensional slice image
42, 42A, 42A1: three-dimensional organ image
42B, 42C, 69: image
43, 45: cut section
44: projection plane
46: rendering image
46A: image
46B: cut pancreas image
46B1: pancreatic duct image
47: side viewpoint image
47A: top viewpoint image
47B: bottom viewpoint image
48: viewpoint
50: ray
52: axial cross section
54: sagittal cross section
56: coronal cross section
57: cross section image
58: axial cross section image
60: sagittal cross section image
62: coronal cross section image
64: pointer
66: line
68: screen
68A1: guide message
68A: guide message display region
68B: side viewpoint key
68B1: viewpoint decision key
68C: normal viewpoint key
68D: enlarged display key
68E: reduced display key
68F: upside viewpoint switching key
68G: downside viewpoint switching key
68H: condition input window
68L operative method input window
70: cross section position information
72: viewpoint calculation expression
72A: top viewpoint calculation expression
72B: bottom viewpoint calculation expression
74: viewpoint position information
76: icon
78: side viewpoint condition information
80: operative method information
82: organ information
88: optical characteristic information
88A: angle-of-view information
88B: distortion characteristic information
100: medical service support system
101: information processing apparatus
102: external communication apparatus
104: processor
106: storage
110: communication OF
112: bus
114: network
A: plane
B: projection plane
C: center point
CL: center line
D, D1: point
F: laparoscope
G: operative field camera
H: port
K: abdomen
L: straight line
P: viewpoint position
P1: top viewpoint position
P2: bottom viewpoint position
PT: patient
S: pancreas
V: voxel
X, Y, Z: arrow

What is claimed is:

1. An image processing device comprising:
a processor,
wherein the processor is configured to
receive a setting of a cut section with respect to an organ shown by a three-dimensional image, and
output, as a first display image that is generated by rendering based on the three-dimensional image and shows the organ, a side viewpoint image having a side viewpoint at which the set cut section is viewed from a direction intersecting a normal line of the cut section, set as a viewpoint of the rendering.

2. The image processing device according to claim 1,
wherein the processor is configured to
output, as a second display image, a cross section image that shows a cross section of a human body including the organ and on which a position of the viewpoint of the first display image is displayed, and
perform display control for displaying the first display image and the second display image in parallel on a display screen.

3. The image processing device according to claim 2,
wherein the cross section image includes a plurality of cross section images that show respective cross sections of an axial cross section, a coronal cross section, and a sagittal cross section.

4. The image processing device according to claim 1,
wherein the processor is configured to
output a plurality of the side viewpoint images having different viewing directions in surroundings of the cut section, and
switch and display the plurality of side viewpoint images as the first display image.

5. The image processing device according to claim 4,
wherein, in a case where a head side in a body axis direction is an upside and an opposite side is a downside,
the plurality of side viewpoint images include at least a first side viewpoint image obtained by viewing the cut section from the upside and a second side viewpoint image obtained by viewing the cut section from the downside.

6. The image processing device according to claim 5,
wherein a first side viewpoint of the first side viewpoint image and a second side viewpoint of the second side viewpoint image are set on a reference line passing through a reference point set in advance within the cut section.

7. The image processing device according to claim 6,
wherein one of the first side viewpoint and the second side viewpoint is settable as an initial position.

8. The image processing device according to claim 7,
wherein the second side viewpoint is set as the initial position.

9. The image processing device according to claim 2,
wherein an intersection position where an extension line in a visual line direction of the set side viewpoint intersects a body surface is displayable.

10. The image processing device according to claim 1,
wherein the side viewpoint is set according to at least one of information based on an input of a user, information regarding the organ, or information regarding an operative method for cutting the organ.

11. The image processing device according to claim 2,
wherein the processor is configured to change another viewpoint in conjunction in a case where the viewpoint is changed in one of the first display image and the second display image on the display screen.

12. The image processing device according to claim 1,
wherein the processor is configured to
acquire optical characteristic information representing an optical characteristic of a camera, and
execute characteristic reflection processing of reflecting the optical characteristic in the first display image based on the optical characteristic information.

13. The image processing device according to claim 12,
wherein at least one of a distortion characteristic or an angle of view is included in the optical characteristic, and
the characteristic reflection processing is processing of reflecting at least one of the distortion characteristic or the angle of view in the first display image.

14. The image processing device according to claim 1,
wherein the first display image is switchable to a viewpoint image obtained by viewing the organ from a viewpoint different from the side viewpoint.

15. An image processing method comprising:
receiving a setting of a cut section with respect to an organ shown by a three-dimensional image; and
enabling to output, as a first display image that is generated by rendering based on the three-dimensional image and shows the organ, a side viewpoint image having a side viewpoint at which the set cut section is viewed from a direction intersecting a normal line of the cut section, set as a viewpoint of the rendering.

16. A non-transitory computer-readable storage medium storing a program that causes a computer to execute a process, the process comprising:
receiving a setting of a cut section with respect to an organ shown by a three-dimensional image; and
enabling to output, as a first display image that is generated by rendering based on the three-dimensional image and shows the organ, a side viewpoint image having a side viewpoint at which the set cut section is viewed from a direction intersecting a normal line of the cut section, set as a viewpoint of the rendering.
